(19) United States
(12) Patent Application Publication
(10) Pub. No.: US 2009/0213392 A1
(43) Pub. Date: Aug. 27, 2009

(54) Printing control device, printing system and printing control program

(75) Inventors: Jun Hoshii, Shiojiri-shi (JP); Takeshi Ito, Nagano-ken (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/317,765

(22) Filed: Dec. 29, 2008

(30) Foreign Application Priority Data
Dec. 28, 2007 (JP) 2007-339576
Dec. 1, 2008 (JP) 2008-306766

(51) Int. Cl. H04N 1/60

(52) U.S. Cl. 358/1.9

(57) ABSTRACT

There are provided a spectral reflectivity estimating unit which estimates spectral reflectivity of a mixed color created by use of a second color material group different from a first color material group on the basis of spectral reflectivity of each of color materials of the second color material group as a mixed-color source and a use ratio of the color materials of the second color material group in the mixed color; a color material set estimating unit which estimates the color material amount set for reproducing spectral reflectivity approximate to the spectral reflectivity of the mixed color on a print medium; and a printing control unit which permits a printing apparatus to perform printing on the basis of the estimated color material amount set.

### BACKGROUND

1. Technical Field

The present invention relates to a printing system and a printing control program, and particularly to a printing control apparatus, a printing system, and a printing control program capable of reproducing a target.

2. Related Art

A printing method paying attention to spectral reproduction was suggested (see Patent Document 1). In Patent Document 1, a combination of printer colors (CMYKOG) is optimized so as to fit with a spectral reflectivity (target spectrum) of a target by use of a printing model, in order to perform printing so as to accord with a target image in terms of a spectrum and a measurement color. By performing the printing on the basis of the printer colors (CMYKOG) in this manner, the target image can be reproduced in terms of spectrum. As a result, it is possible to obtain a print result of high reproduction in terms of the measurement color.

[Patent Document 1] JP-T-2005-508125

In a printing industry, a necessity or a demand for creating a print result by another printing apparatus such as a proof or the like for confirming the print result before actual printing has been increased even in a situation where there is no printing apparatus. A demand for actually printing colors formed by mixing formed colors (such as printed colors, color existing in the natural world, colors formed in printings, cultural assets, documents, or the like, or colors of painting tools) and viewing the colors with eyes has also been increased. The demand can be realized by preparing an LUT or the like corresponding color spaces of printing apparatuses in advance between the printing apparatuses to perform printing on the basis of the prepared LUT. In this case, when the LUT having a large capacity is stored, a memory capacity may be insufficient. In addition, when another printing apparatus permitted to reproduce the print result is not designated, the preparation of this LUT is not practical. Estimation of a result obtained by mixing formed colors other than the print result cannot be realized in the original LUT or the like.

### SUMMARY

The invention is devised in view of the above-mentioned problems and an object of the invention is to provide a printing control device, a printing system, and a printing control program capable of estimating mixed colors of a color material group different from a color material group used in a printing apparatus performing actual printing and permitting the printing apparatus to print the estimated mixed colors to be viewable.

In order to solve the problems mentioned above, a printing control device includes a printing unit, a spectral reflectivity estimating unit, a color material amount set estimating unit, and a mixed-color print unit. The printing unit refers to a lookup table defining a correspondence relation between a color material amount set and an index, designates the color material amount set corresponding to the designated index to the printing apparatus, and permits the printing apparatus to perform printing. In the lookup table referred in the printing, the color material amount set estimated so that a mixed color formed by use of a second color material group is reproduced in a print medium is defined in correspondence with the index specifying the mixed color. The second color material group is a color material group different from the first color material group. The color material amount set for reproducing the mixed color on the print medium by use of the first color material group is estimated so that spectral reflectivity approximate to spectral reflectivity estimated by a predetermined estimation model on the basis of spectral reflectivity of each of color materials of the second color material group as a mixed-color source and a use ratio of color materials of the second color material group in the mixed color is reproduced in the print medium. According to the color material amount set for reproducing the spectral reflectivity approximate to the spectral reflectivity of the mixed color on the print medium, it is possible to obtain a print result expressing the same colors as colors generated by actually mixing color materials which are a foundation of the mixed color, even when a light source is changed.

A spectral reflectivity acquiring unit may acquire the spectral reflectivity by actually measuring the spectral reflectivity for the color material or the spectral reflectivity of the color material may be input by a user or the like. The printing apparatus capable of at least attaching the plural color materials onto the print medium can be used. In addition, the invention is applicable to various printing apparatuses such as an ink jet printer, a laser printer, and a sublimation printer.

In the estimation of the color material amount set described above, the color material amount set estimating unit may estimate the color material amount set by permitting a spectral reflectivity estimating unit to repeatedly change a use ratio of the color materials of the first color material group so that a result estimated by the spectral reflectivity estimating unit on the basis of spectral reflectivity of each of the color materials of the first color material group and the use ratio of the color materials of the first color material group becomes spectral reflectivity approximate to spectral reflectivity of the mixed color. With such a configuration, when the result of the mixed color of the second color material group is reproduced by use of the first color material group, the printing can be performed with the most appropriate color material set.

The estimation of an approximation degree of the estimated color material amount set is performed on the basis of an evaluation value used to evaluate approximation to the spectral reflectivity of the mixed color, while adding a weight which is different depending on a wavelength. As an example suitable for the weight, the weight may be set on the basis of a spectral sensitivity characteristic of human eyes. In this way, since the spectral reflectivity can be approximated preferably for wavelengths sensitive to human spectral sensitivity, it is possible to obtain the print result having a satisfactory reproduction precision of visibility. As a more specific example, the weight may be set on the basis of linear combination of color-matching functions corresponding to tristimulus values. With such a configuration, it is possible to set the weight in which the wavelength region corresponding to the color-matching functions corresponding to the tristimulus is synthetically valued.

The weight may be set on the basis of the spectral reflectivity of the mixed color. For example, since it is considered that in the wavelength region having a spectrum in which the spectral reflectivity of the mixed color is strong, the approximation to the spectral reflectivity finally has a considerable influence on visibility, it is desirable that this wavelength region is preferably approximated. In addition, the weight may be set on the basis of a spectral energy distribution of a predetermined light source. By setting the weight on the basis of the spectral energy distribution of the predetermined light source, it is possible to preferably approximate the wavelength region in which the light source has a strong spectrum. Moreover, it is possible to improve visual reproduction in this light source. In addition, by synthetically taking the reproduction both under a single light source and under the plural light source into consideration, the weight may be set on the basis of the linear combination of spectral energies of the plural light sources.

The technical spirit of the invention can be embodied as a method as well as a specific printing control apparatus. That is, the invention can be embodied by the method including steps corresponding to constituent units of the printing control apparatus described above. Of course, when the printing control apparatus described above reads a program to execute the constituent units described above, the technical spirit of the invention can be embodied even in the program executing functions corresponding to the constituent units or various record media recording the program. In addition, the printing control apparatus according to the invention may be a single apparatus and may be present in plural apparatuses in a distribution manner. For example, each of constituent units included in the printing control apparatus may be distributed both to a printer driver executed in a personal computer and a printer. The constituent units of the printing control apparatus according to the invention can be included in the printing apparatus such as a printer.

### BRIEF DESCRIPTION OF THE DRAWINGS

FIG. 1 is a block diagram illustrating the hardware configuration of a printing control device.

FIG. 2 is a block diagram illustrating the software configuration of the printing control apparatus.

FIG. 3 is a flowchart illustrating a flow of print data generation process.

FIG. 4 is a diagram illustrating an example of a UI screen X.

FIG. 5 is an explanatory diagram illustrating calculation for a color value on the basis of spectral reflectivity.

FIG. 6 is a diagram illustrating print data.

FIG. 7 is a diagram illustrating an index table.

FIG. 8 is a flowchart illustrating a flow of a mixed-color print data generating process.

FIG. 9 is a diagram illustrating an example of a UI screen Y.

FIG. 10 is a flowchart of an overall flow of a printing control process.

FIG. 11 is a flowchart of a flow of a 1D-LUT generating process.

FIG. 12 is a schematic diagram illustrating a flow of a process of optimizing an ink amount set.

FIG. 13 is a schematic diagram illustrating optimization of the ink amount set.

FIG. 14 is a diagram illustrating a 1D-LUT.

FIG. 15 is a flowchart illustrating a flow of a printing control data generating process.

FIG. 16 is a diagram illustrating a 3D-LUT.

FIG. 17 is a schematic diagram illustrating a printing method of a printer.

FIG. 18 is a diagram illustrating a spectral reflectivity database.

FIG. 19 is a diagram illustrating a spectral neugebauer model.

FIG. 20 is a diagram illustrating a cell division Yule-Nielsen spectral neugebauer model.

FIG. 21 is a schematic diagram illustrating a weight function according to a modified example.

FIG. 22 is a schematic diagram illustrating a weight function according to a modified example.

FIG. 23 is a schematic diagram illustrating a weight function according to a modified example.

FIG. 24 is diagram illustrating UI screens according to a modified example.

FIG. 25 is a schematic diagram illustrating an evaluation value according to a modified example.

FIG. 26 is a diagram illustrating the software configuration of a printing system according to a modified example.

FIG. 27 is a diagram illustrating the software configuration of a printing system according to a modified example.

FIG. 28 is a flowchart illustrating a target color searching process according to a modified example.

FIG. 29 is diagram illustrating an example a user interface (UI) according to a modified example.

FIG. 30 is an explanatory diagram illustrating a method of designating a range on the basis of a color attribute according to a modified example.

### BRIEF DESCRIPTION OF THE CODE

10: COMPUTER
11: CPU
12: RAM
13: ROM
14: HDD
15: GIF
16: VIF
17: IIF
18: BUS
P1: OS
P1a: GDI
P1b: SPOOLER
P2: APL
P2a: UIM
P2b: MCM
P2c: PDG
P3a: LUG
P3b: PDV
P3a1: ICM
P3a2: RPM
P3a3: ECM
P3a4: LOM
P4: MDV
P5: DDV

### DESCRIPTION OF EXEMPLARY EMBODIMENTS

Hereinafter, an embodiment of the invention will be described in the following order:

1. Configuration of Printing Control Device,

2. Print Data Generating Process,

3. Mixed-Color Print Data Generating Process

4. Printing Control Process,

4-1. 1D-LUT Generating Process,

4-2. Printing Control Data Generating Process,

5. Spectral Printing Model,

6. Modified Examples,

6-1. Modified Example 1,

6-2. Modified Example 2,

6-3. Modified Example 3,

6-4. Modified Example 4,

6-5. Modified Example 5,

6-6. Modified Example 6, and

6-7. Modified Example 7.

### 1. Configuration of Printing Control Apparatus

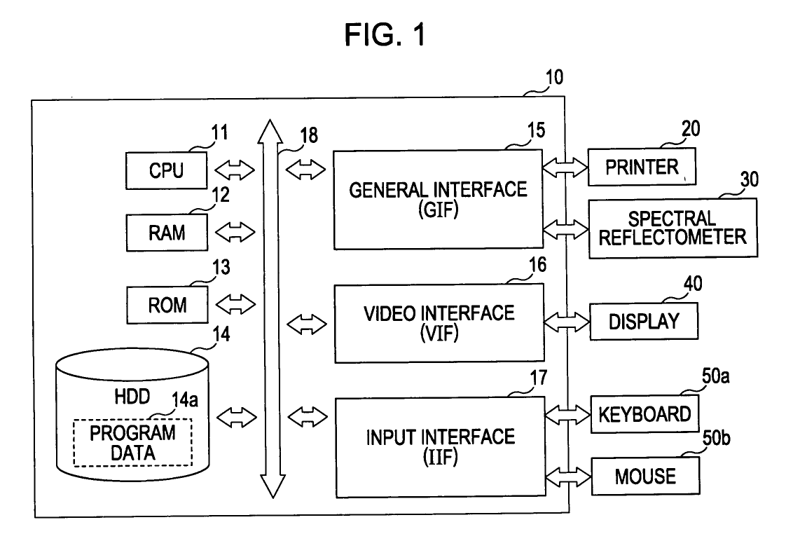

FIG. 1 is a diagram illustrating the hardware configuration of a printing control apparatus according to an embodiment of the invention. In the drawing, the printing control apparatus is configured mainly by a computer 10. The computer 10 includes a CPU 11, a RAM 12, a ROM 13, a hard disk drive (HDD) 14, a general interface (GIF) 15, a video interface (VIF) 16, an input interface (IIF) 17, and a bus 18. The bus 18 is a unit which carries out data communication between the constituent units 11 to 17 included in the computer 10, and the data communication is controlled by a chip set (not shown) or the like. The HDD 14 stores program data 14a executing various programs in addition to an operating system (OS). Therefore, the CPU 11 executes calculating according to the program data 14a while loading the program data 14a on the RAM 12. The GIF 15 is an interface conforming to a USB standard, for example and connects an external printer 20 and a spectral reflectometer 30 to the computer 10. The VIF 16 connects the computer 10 to an external display 40, and provides an interface for displaying an image on the display 40. The IIF 17 connects the computer 10 to an external keyboard 50a and a mouse 50b, and provides an interface for allowing the computer 10 to acquire input signals from the keyboard 50a and the mouse 50b.

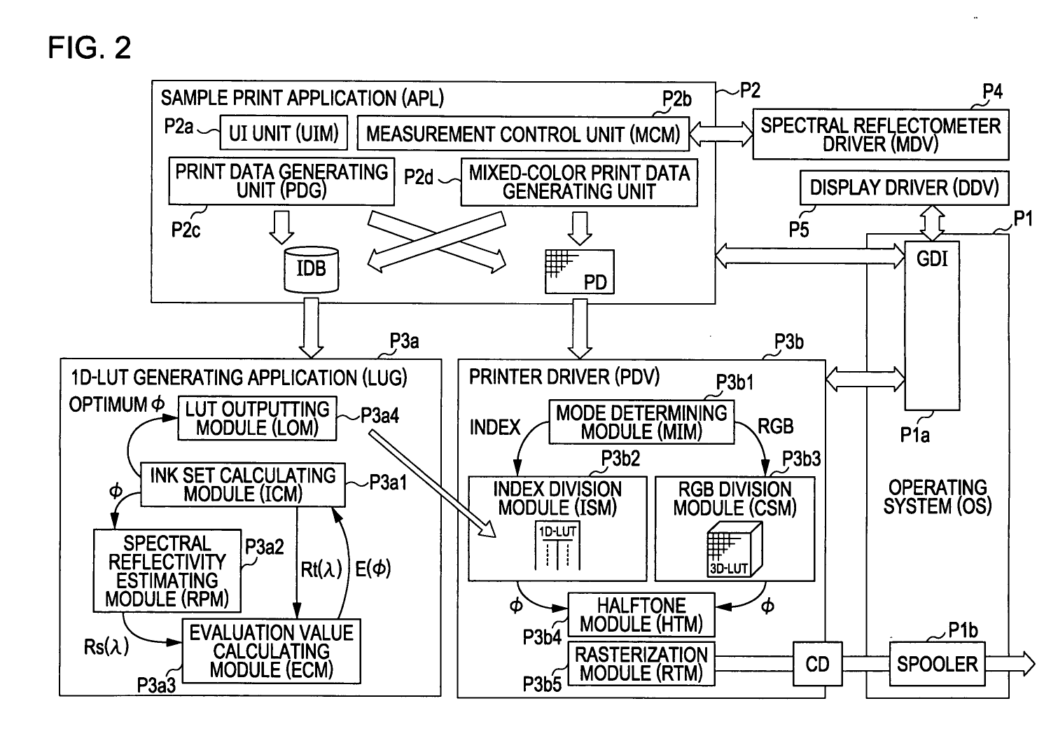

FIG. 2 is a diagram illustrating the software configuration of programs executed in the computer 10 along with an overall flow of data. In the drawing, the computer 10 mainly executes an OS P1, a sample print application (APL) P2, a 1D-LUT generating application (LUG) P3a, a printer driver (PDV) P3b, a color measurement device driver (MDV) P4, and a display driver (DDV) P5. The OS P1 is one of APIs in which each program is usable and includes an image apparatus interface (GDI) P1a and a spooler P1b. Therefore, the GDI P1a is called by request of the APL P2, and additionally the PDV P3b or the DDV P5 is called by request of the GDI P1a. The GDI P1a has a general configuration in which the computer 10 controls image output of an image output apparatus such as the printer 20 and the display 40. One of the PDV P3b and the DDV P5 provides a process inherent in the printer 20 or the display 40. The spooler P1b executes a job control or the like through the APL P2, the PDV P3b, or the printer 20. The APL P2 is an application program for printing a sample chart SC and generates print data PD having an RGB bitmap format to output the print data PD to the GDI P1a. When the APL P2 generates the print data PD, the APL P2 acquires color measurement data MD of a target from the MDV P4. The MDV P4 controls the color measurement device 30 by request of the APL P2 and outputs the measurement color data RD obtained by the control to the APL P2.

The print data PD generated by the APL P2 is output to the PDV P3b through the GDI P1a or the spooler P1b. The PDV P3b generates printing control data CD which can be output to the printer 20 on the basis of the print data PD. The printing control data CD generated by the PDV P3b is output to the printer 20 through the spooler P1b included in the OS P1, and the sample chart SC is printed on a print sheet by allowing the printer 20 to operate on the basis of the printing control data CD. An overall process flow has been described. Hereinafter, processes executed by the programs P1 to P4 will be described in detail with reference to a flowchart.

### 2. Print Data Generating Process

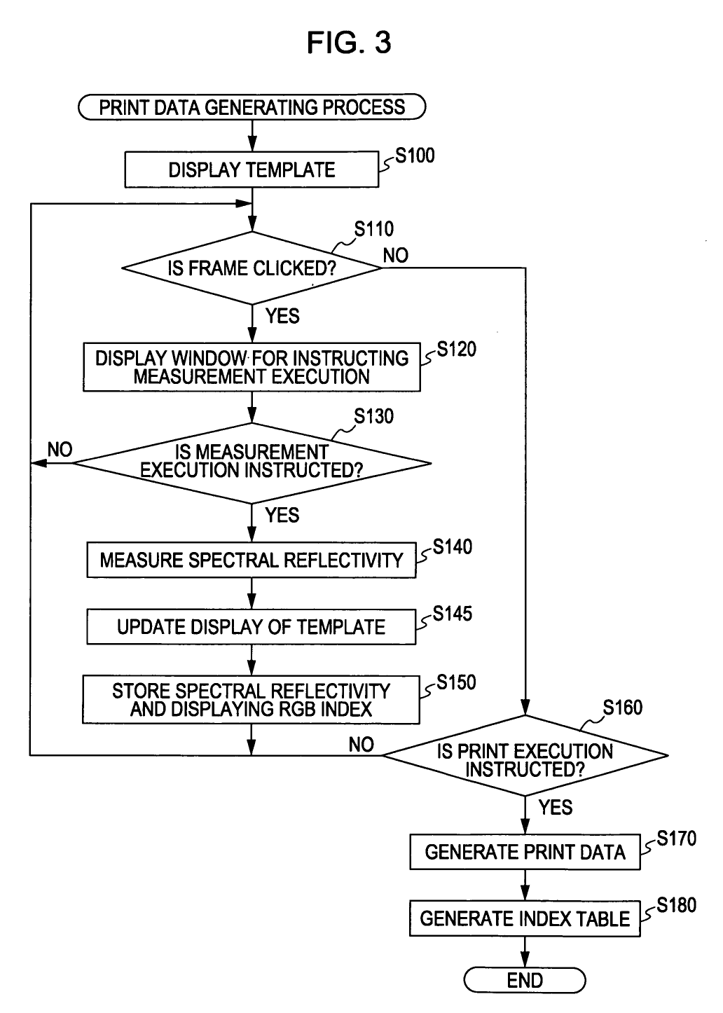

FIG. 3 is a flowchart illustrating a flow of print data generation executed by the APL P2. As shown in FIG. 2, the APL P2 includes a UI module (UIM) P2a, a measurement control module (MCM) P2b, a print data generating module (PDG) P2c, and a mixed-color print data generating module P2d. The modules P2a, P2b, P2c execute steps shown in FIG. 3. The mixed-color print data generating module P2d is a module performing a mixed-color generating process in Section 3 or Sections 6 and 7 described below. In Step S100, the UIM P2a allows the GDI P1a and the DDV P5 to display a UI screen X for receiving a print command instructing the sample chart SC to be printed. The UI screen X is provided with a display showing a template of the sample chart SC.

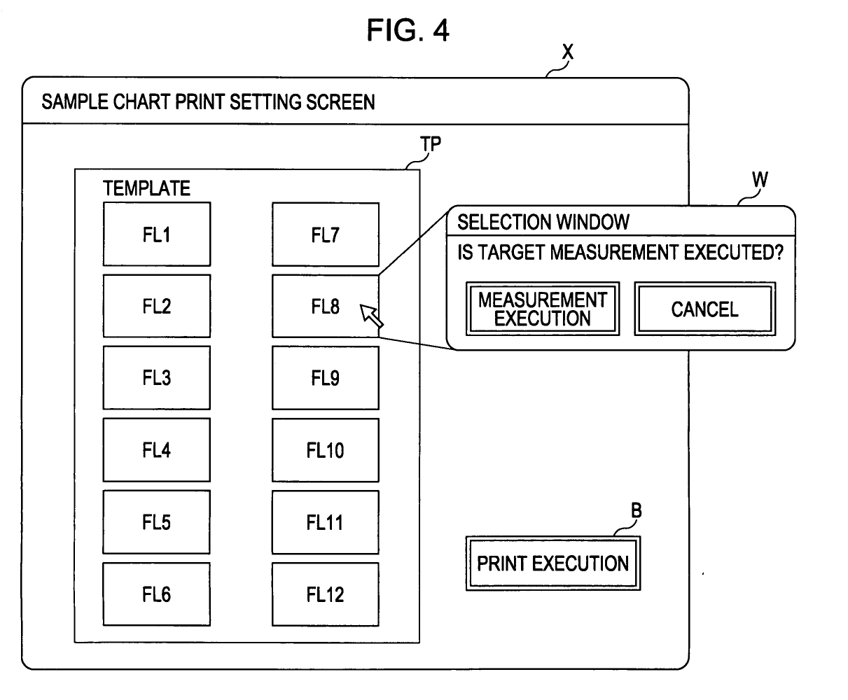

FIG. 4 is a diagram illustrating an example of the UI screen X. In the drawing, a template TP is displayed. The template TP is provided with twelve frames FL1 to FL12 for laying out color patches. Each of the frames FL1 to FL12 can be selected on the UI screen X by click of the mouse 50b. Upon clicking each of the frames FL1 to FL12, a selection window W used to instruct whether to start measurement of spectral reflectivity is displayed. In addition, the UI screen X is also provided with a button B1 used to instruct whether to execute print of the sample chart SC. In Step S110, click of each of the frames FL1 to FL12 by the mouse 50b is detected on the UIM P2a. When the click is detected, the selection window W used to instruct whether to start the measurement of the spectral reflectivity is displayed in Step S120. In Step S130, click by the mouse 50b is detected on the selection window W. When a cancel is clicked, the step returns to Step S110. Alternatively, when a measurement execution of the spectral reflectivity is clicked, the MCM P2b allows the spectral reflectometer 30 to measure a target spectral reflectivity Rₜ (λ) as a spectral reflectivity R (λ) of the target TG through the MDV P4 and acquires the spectral reflectivity data RD storing the target spectral reflectivity Rₜ (λ) in Step S140.

When the measurement of the target spectral reflectivity Rₜ (λ) is completed in Step S140, a color value (L*a*b* value) in a CIELAB color space upon radiating a D65 light source as the most standard light source is calculated. In addition, the L*a*b* value is converted into an RGB value by use of a predetermined RGB profile and the RGB value is acquired as a displaying RGB value. The RGB profile is a profile which defines a color matching relation between the CIELAB color space as an absolute color space and the RGB color space in this embodiment. For example, an ICC profile is used.

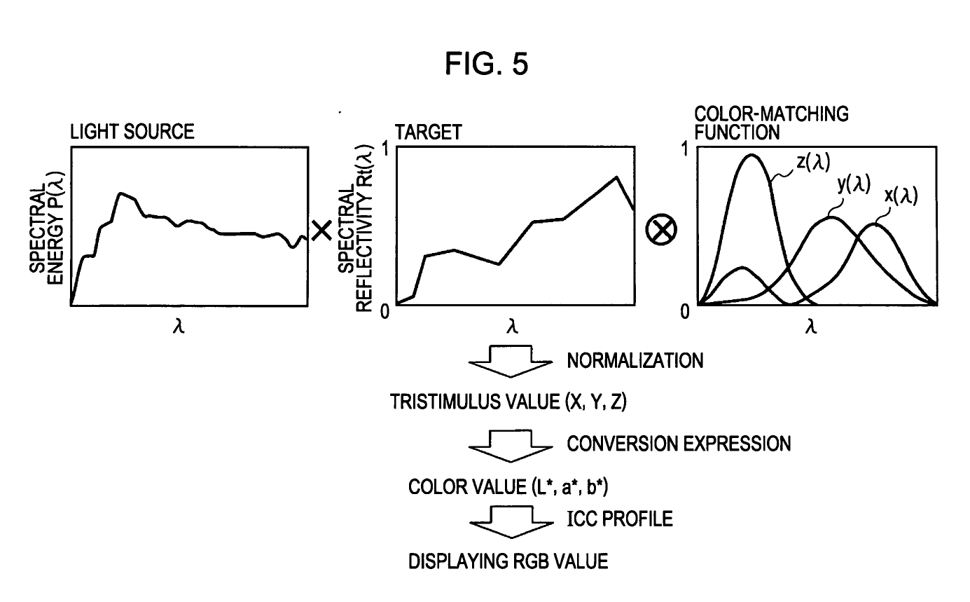

FIG. 5 is a schematic diagram illustrating calculation of the displaying RGB value from the spectral reflectivity data RD in Step S140. When the target spectral reflectivity Rₜ (λ) of the target TG is measured, the spectral reflectivity data RD expressing a distribution of the target spectral reflectivity Rₜ (λ) illustrated in the drawing is obtained. In addition, the target TG means a surface of an object which is a target of spectral reproduction. For example, the target TG is a surface of an artificial object or a natural object formed by another printing apparatus or a coating apparatus. On the other hand, the D65 light source has a distribution of non-uniform spectral energy P (λ) in a visible wavelength region shown in the drawing. In addition, spectral energy of reflected light of each wavelength obtained when the D65 light source is radiated to the target TG is a value obtained by a product of the target spectral reflectivity Rₜ (λ) and the spectral energy P (λ) in each wavelength. In addition, tristimulus values X, Y, and Z are obtained by a convolution integral of color-matching functions x (λ), y (λ), and z (λ) replied to a spectral sensitivity characteristic of a human for a spectrum of the spectral energy of reflected light and by normalization for a coefficient k. When the above description is expressed an expression, Expression (1) is obtained as follows:

[Expression 1].

X=k∫P(λ)Rₜ(λ)x(λ)d λ

Y=k∫P(λ)Rₜ(λ)y(λ)dλ (1)

Z=k∫P(λ)Rₜ(λ)z(λ)dλ

By converting the tristimulus values X, Y, and Z by a predetermined conversion expression, it is possible to obtain an L*a*b* value indicating a color formed when the D65 light source is radiated to the target TG. Additionally, by using an RGB profile, it is possible to obtain the displaying RGB value. In Step S145, each of the frames FL1 to FL12 clicked on the template TP is updated to a display colored by the displaying RGB value. In this way, the color of the target TG in the D65 light source which is a standard light source can be grasped sensuously on the UI screen. When Step S145 is completed, a proper index is generated and stored in the RAM 12 in Step S150, by allowing the index, location information of the frames FL1 to FL12 clicked in Step S110, and the displaying RGB value to correspond to the spectral reflectivity data RD. When Step S150 is completed, the process returns to Step S110 and Steps S120 to S150 are repeatedly executed. Therefore, another of the frames FL1 to FL12 is selected and the target spectral reflectivity Rₜ (λ) of the another target TG can be measured for the another of the frames FL1 to FL12.

In this embodiment, twelve different targets TG1 to TG12 are prepared and the target spectral reflectivity Rₜ (λ) for each of the targets TG1 to TG12 is obtained as the spectral reflectivity data RD. Therefore, in Step S150, data obtained in correspondence with the spectral reflectivity data RD for each of the frames FL1 to FL12 and the proper index are sequentially stored in the RAM. In addition, each value of the index may be generated so as to become a proper value, an increment value, or a random value without repetition.

When a click of each of the frames FL1 to FL12 is not detected in Step S110, a click of a button B1 instructing print execution of the sample chart SC is detected in Step S160. When the click of the button is not detected, the process returns to Step S110. Alternatively, when the click of the button B1 instructing the print execution of the sample chart SC is detected, the PDG P2c generates the print data PD in Step S170.

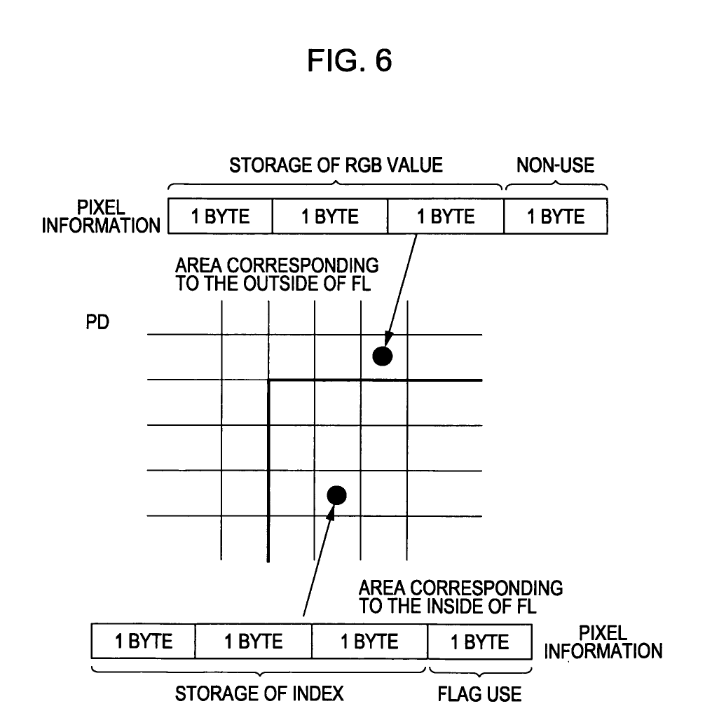

FIG. 6 is a schematic diagram illustrating the configuration of the print data PD. In the drawing, the print data PD is constituted by numerous pixels arranged in a dot matrix shape and each pixel has 4-byte (8 bits×4) information. The print data PD expresses the same image as that of the template TP shown in FIG. 4. Pixels other than pixels of areas corresponding to the frames FL1 to FL12 of the template TP have the RGB value of a color corresponding to the template TP. A gray scale value of each channel of RGB is expressed by eight bits (256 gray scales) and three bytes of the four bytes described above are used to store the RGB value. For example, when a color outside the frames FL1 to FL12 of the template TP is displayed with the same intermediate gray such as (R, G, B)=(128, 128, 128), the pixels outside the areas corresponding to the frames FL1 to FL12 in the print data PD have color information of (R, G, B)=(128, 128, 128). In addition, the one remaining byte is not used.

On the other hand, the pixels of the areas corresponding to the frames FL1 to FL12 of the template TP have 4-byte information. Normally, an index is stored using three bytes with which the RGB value is stored. The index is proper to each of the frames FL1 to FL12 generated in Step S150. The PDG P2c acquires the index from the RAM 12 and stores an index corresponding to the pixels of each of the frames FL1 to FL12. A flag indicating that the index is stored using the one remaining byte is set for the pixels corresponding to each of the frames FL1 to FL12 in which the index is stored instead of the RGB value. In this way, it is possible to know whether each pixel stores the RGB value and whether each pixel stores the index. In this embodiment, since three bytes are used in order to store the index, it is necessary to generate an index which can be expressed with information of three or less bytes in Step S150. When the print data PD having a bitmap format can be generated in this manner, the PDG P2c generates an index table IDB in Step S180.

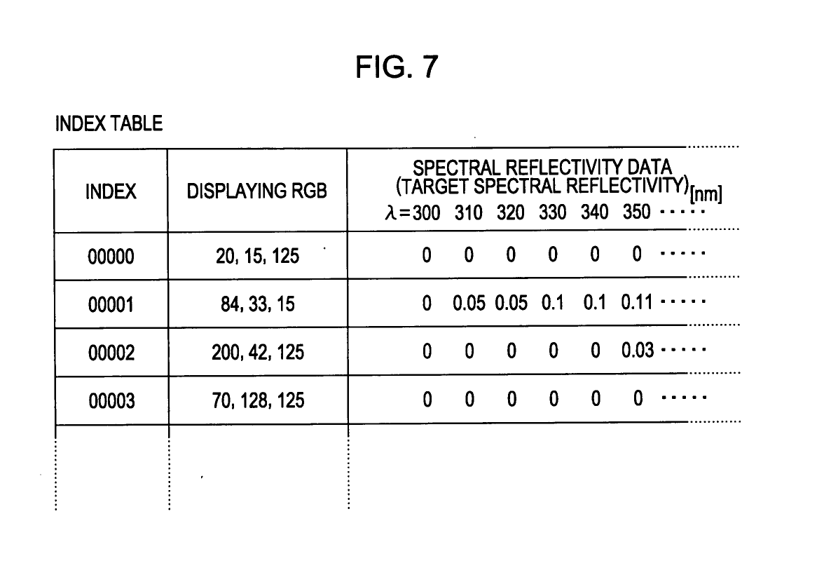

FIG. 7 is a diagram illustrating an example of the index table IDB. In the drawing, the target spectral reflectivity Rₜ (λ) obtained by measurement and the displaying RGB value corresponding to the L*a*b* value in the D65 light source are stored in each of the proper indexes generated in correspondence with the frames FL1 to FL12. When the generation of the index table IDB is completed, the print data PD is output to the PDV P3b via the GDI P1a or the spooler P1b. Since the print data PD formally has the same format as a general RGB bitmap format, the print data PD can also be processed like a general printing job even by the GDI P1a or the spooler P1b supplied by the OS P1. On the other hand, the index table IDB is output directly to the PDV P3b. In this embodiment, the index table IDB is newly generated. However, a new correspondence relation among the index, the target spectral reflectivity Rₜ (λ), and the displaying RGB value is added to the existing index table IDB. In addition, it is not necessary to successively perform the print data generating process described above and a printing control process described below in the same apparatus, but the print data generating process and the printing control process may be individually performed in a plurality of computers connected to each other through a communication line such as an LAN or the Internet.

### 3. Mixed-Color Print Data Generating Process

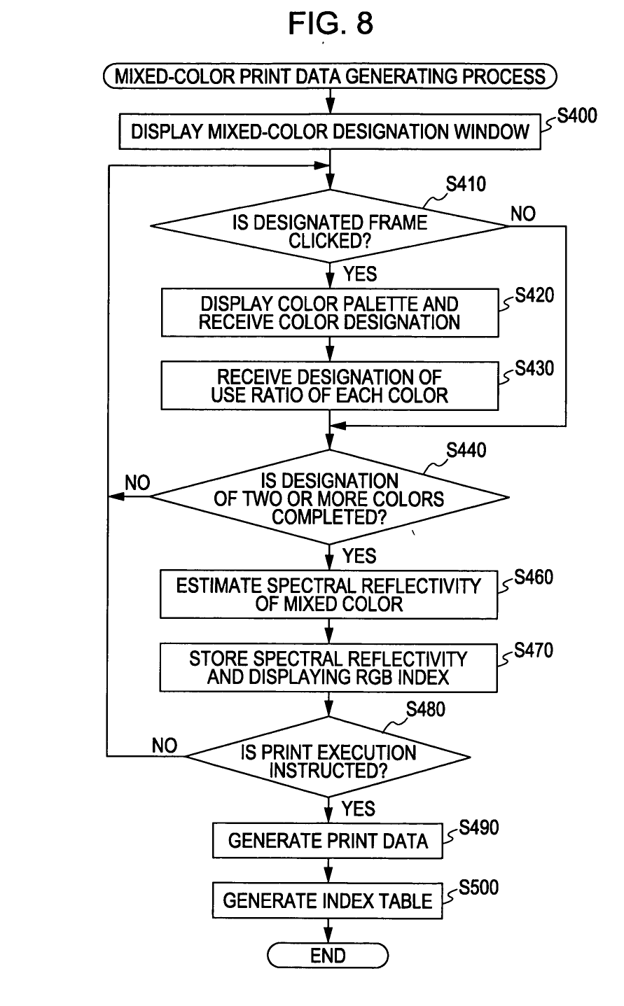

The APL P2 can also generate mixed-color print data. FIG. 8 is a diagram illustrating a flow of a mixed-color print data generating process performed mainly by the color-mixed print data generating unit P2b. In Step S400, the UIM P2a displays a UI screen Y for receiving a print instruction used to create mixed colors and print the created mixed colors through the GDI P1a and the DDV P5.

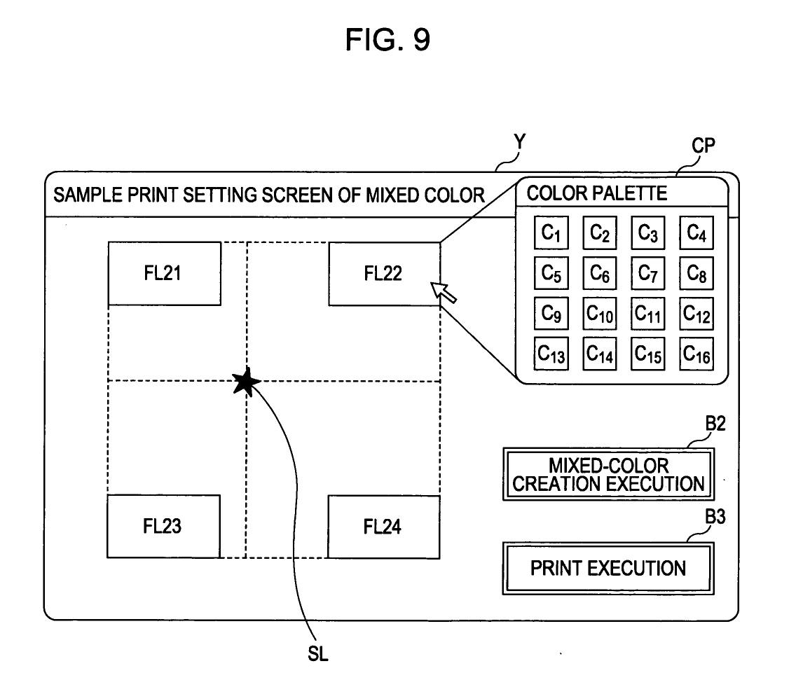

FIG. 9 is a diagram illustrating an example of the UI screen Y. In UI screen Y shown in the drawing, designation frames FL21 to FL24 for designating colors which are a foundation of the mixed colors are provided. The designation frames FL21 to FL24 are configured to be selected by click of the mouse 50b. When the designation frames FL21 to FL24 are clicked, a color palette CP pop up as a new window. The color palette CP displays a list of color samples CL1 to CL16 which are the foundation of the mixed color. When one of the color samples CL1 to CL16 is clicked by the mouse 50b, a clicked color is designated for a designation frame. In addition, on the UI screen Y, a slider SL for designating a ratio of the mixed colors and a button B2 for instructing estimation of the mixed colors are provided. In FIG. 9, four designation frames are displayed in the corners of a square and four mixed colors are configured to be created. Since the slider SL is displayed between the designation frames, a use ratio (a ratio at which colors of the designation frames are used in color-mixing) of colors of the designation frames is determined at the location of the slider SL. Of course, in a case of two or more colors, an arbitrary number of colors can be mixed.

When the mixed-color print data generating process starts, the UI screen Y for designating the mixed colors is displayed in Step S400. Subsequently, in Step S410, the designation of the colors which are the foundation of the mixed colors is received. Specifically, the UIM P2a detects that one of the designation frames FL21 to FL24 is clicked by the mouse 50b. When the click is detected, the process proceeds to Step S420 to pop up the window of the color palette CP. Then, it is detected that one of the color samples CL1 to CL16 of the color palette CP is clicked, the detected color sample is received, the received color sample is set for the designation frame clicked in Step S400, and then the process proceeds to Step S430. This color sample is displayed on the designation frame in which the color sample is set. Alternatively, when the click of the mouse 50b is not detected in Step S410, the process proceeds to Step S440.

Subsequently, in Step S430, designation of the use ratio is received. Specifically, the UIM P2a detects drag and drop of the slider SL by the mouse 50b. When the drag and drop is detected, the slider SL is moved in accordance with the drag and drop movement of the mouse 50b. In order to designate the use ratio in more detail, various methods of designating the use ratio such as a method of inputting the use ratio of the sample color with a numerical value can be used.

Subsequently, in Step S440, it is determined whether the color sample is set on two or more frames among the designation frames FL21 to FL24. When the color sample is not set on the two or more designation frames, the color mixing is not possible. Therefore, the process returns to Step S410. Alternatively, when the color sample is set on the two or more frames, the process proceeds to Step S450.

In Step S450, it is determined whether estimation of the mixed color starts. Specifically, the UIM P2a detects click of the button B2 by the mouse 50b. When the click is detected, the process proceeds to Step S460 to calculate spectral reflectivity of the mixed color. Alternatively, when the click of the button B2 by the mouse 50b is not detected, the process returns to Step S410.

In Step S460, estimation of the spectral reflectivity of the mixed color formed by mixing the color sample designated on the designation frame at the use ratio designated in the slider SL is performed. The spectral reflectivity of the mixed color can be calculated by linear combination of weighting the spectral reflectivity of each color sample in accordance with the use ratio or by a neugebauer model in a spectral printing model, which is described below in Section 4. For example, when the mixed colors of the color samples of four colors are calculated by the linear combination, a spectral reflectivity Rmix (λ) of mixed color, which is made by mixing a color sample of spectral reflectivity R1 (λ), a color sample of spectral reflectivity R2 (λ), a color sample of spectral reflectivity R3 (λ), and a color sample of spectral reflectivity R4 (λ), at a ratio of f1:f2:f3:f4 (where f1+f2+f3+f4=1, 0≦f1≦1, 0≦f2≦1, 0≦f3≦1, 0≦f4≦1) can be calculated by an expression of Rmix (λ)=f1×R1 (λ)+f2×R2 (λ)+f3×R3 (λ)+f4×R4 (λ).

Likewise, when the mixed colors of the color samples of four colors are calculated by use of a cell division Yule-Nielsen spectral neugebauer model of the spectral printing model, colors designated on the designation frames FL21 to FL24 are used instead of an ink set (CMY, CMYKlclm, or the like) in the spectral printing model of Section 4 and the use ratio designated on the slider SL is used instead of the ink amount set.

In the estimation of the mixed colors, the mixed colors of the plural color samples described above can be estimated and a print result in another printer can be estimated. That is, spectral reflectivity of a color created by combination of an ink set in another printer P other than the printer 20 performing actual printing can be estimated. More specifically, by constructing a spectral reflectivity database on the basis of the ink set used in the other printer P by the spectral printing model in Section 4 described below, the spectral reflectivity obtained upon inputting the arbitrary ink amount set used in the other printer P can be estimated. The ink set used in the printer P or the colors received on the designation frames FL from the above-described color palette CP as the colors which are the foundation of the mixed colors correspond to a second color material group. On the other hand, the ink set used in the printer 20 corresponds to a first color material group.

When the calculation of the spectral reflectivity Rmix (λ) in Step S460 is completed, a proper index is created and stored in the RAM 12 by corresponding the proper index with the spectral reflectivity data RD in Step S470. A color value (L*a*b* value) in the CIELAB color space upon radiating the D65 light source as the most standard light source is calculated for the spectral reflectivity data RD. In addition, the L*a*b* value is converted into an RGB value by use of a predetermined RGB profile and stored in the RAM 12 by corresponding the RGB value as a displaying RGB value with the color measurement data MD. The RGB profile is a profile defining a color-matching relation between the CIELAB color space as an absolute color space and the RGB color space according to this embodiment. For example, an ICC profile can be used. Since calculation of the display RGB value from the spectral reflectivity data RD is the same as that of the print data generating process described above, the description is omitted.

Subsequently, in Step S480, it is determined whether the click of the button B3 for executing mixed-color printing is detected. When the click is not detected, the process returns to Step S410. Alternatively, when the click of the button B3 for executing the mixed-color printing is detected, the PDG P2c generates the print data PD in Step S490. The print data is generated in the same manner as the print data generating process described above. When the print data PD is generated, the PDG P2c generates an index table IDB in Step S500. The index table IDB is also generated in the same manner as the print data generating process described above. When the generation of the index table IDB is completed, the print data PD is output to the PDV P3b through the GDI P1a or the spooler P1b. On the other hand, the index table IDB is directly output to the PDV P3b.

### 4. Printing Control Process

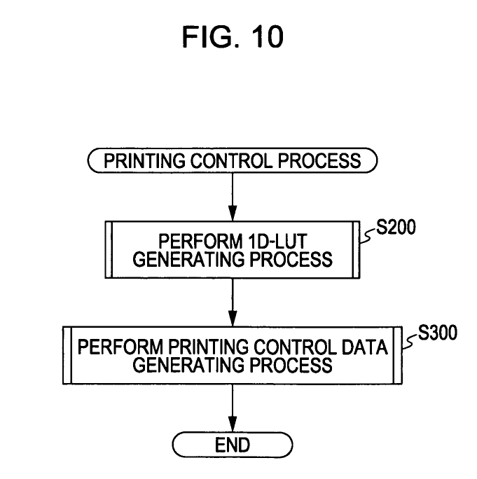

FIG. 10 shows an overall flow of the printing control process performed by the LUG P3a and the PDV P3b. A 1D-LUT generating process (Step S200) is performed by the LUG P3a and a printing control data generating process (Step S300) is performed by the PDV P3b. The 1D-LUT generating process may be performed before the printing control data generating process or the 1D-LUT generating process and the printing control data generating process may be performed together.

### 4-1. 1D-LUT Generating Process

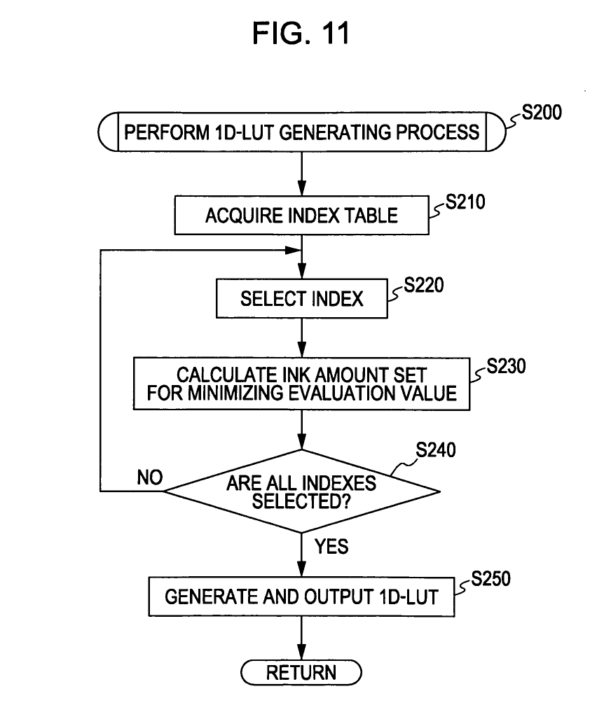

FIG. 11 is a flowchart illustrating a flow of the 1D-LUT generating process. The LUG P3a shown in FIG. 2 includes an ink amount set calculating module (ICM) P3a1, a spectral reflectivity estimating module (RPM) P3a2, an evaluation value calculating module (ECM) P3a3, and an LUT output module (LOM) P3a4. In Step S210, the ICM P3a1 acquires the index table IDB. In Step S220, one of indexes is selected from the index table IDB and the spectral reflectivity data RD corresponding to the selected index is acquired. In Step S230, the ICM P3a1 calculates an ink amount set in which the spectral reflectivity R (λ) which is the same as the target spectral reflectivity Rₜ (λ) or the mixed-color spectral reflectivity Rmix (λ) indicated by the spectral reflectivity data RD is reproducible. At this time, the RPM P3a2 and the ECM P3a3 described above are used.

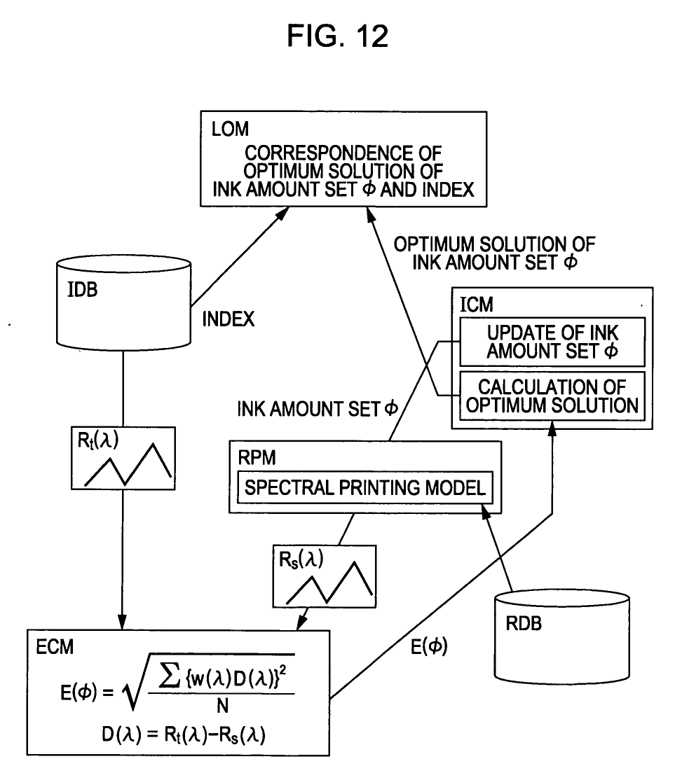

FIG. 12 is a schematic diagram illustrating the calculation flow of the ink amount set in which the spectral reflectivity R (λ) which is the same as the target spectral reflectivity Rₜ (λ) or the mixed-color spectral reflectivity Rmix (λ) indicated by the spectral reflectivity data RD is reproducible. The RPM P3a2 estimates the spectral reflectivity R (λ) obtained when the printer 20 ejects ink onto a predetermined print sheet on the basis of an ink amount set Φ upon inputting the ink amount set Φ from the ICM P3a1, and outputs the spectral reflectivity R (λ) as an estimation spectral reflectivity Rₛ (λ) to the ECM P3a3.

The ECM P3a3 calculates a difference D (λ) between the target spectral reflectivity Rₜ (λ) or the mixed-color spectral reflectivity Rmix (λ) indicated by the spectral reflectivity data RD and the estimation spectral reflectivity Rₛ (λ) for each wavelength λ, and multiplies the difference D (λ) by a weight function w (λ) of a weight and each wavelength λ. A square root of a square mean of this value is calculated as an evaluation value E (Φ). When the above calculation is expressed as an expression, Expression (2) is expressed as follows:

$$\begin{matrix}[ Expression 2 ] & \\ E ( φ ) = \sqrt{\frac{\sum {\{ w ( λ ) D ( λ ) \}}^{2}}{N}} \\ D ( λ ) = {R}_{t} ( λ ) - {R}_{s} ( λ ) . & ( 2 )\end{matrix}$$

In Expression (2), N indicates a finite division number of a wavelength λ. In Expression (2), a difference between the target spectral reflectivity Rₜ (λ) or the mixed-color spectral reflectivity Rmix (λ) and the estimation spectral reflectivity Rₛ (λ) in each wavelength λ becomes smaller, as the evaluation value E (Φ) is smaller. That is, as the evaluation value E (Φ) is smaller, a spectral reflective R (λ) reproduced in a print medium when the printer 20 performs printing in accordance with the input ink amount set Φ can be said to approximate to the target spectral reflectivity Rₜ (λ) or the mixed-color spectral reflectivity Rmix (λ) obtained from the corresponding target TG. Additionally, according to Expression (1) described above, it can be known that an absolute color value, which is expressed by the target TG corresponding to a print medium when the printer 20 performs printing on the basis of the ink amount set Φ in accordance with variation in a light source, varies in both the target spectral reflectivity Rₜ (λ) and the estimation spectral reflectivity Rₛ (λ), but when the spectral reflective R (λ) approximate to the target spectral reflectivity Rₜ (λ), a relatively same color is perceived regardless of the variation in the light source. Accordingly, according to the ink amount set Φ in which the evaluation value (Φ) becomes small, it is possible to obtain a print result that the same color as that of the target TG is perceived in all light sources.

In this embodiment, the weight function w (λ) uses Expression (3) as follows:

[Expression 3].

w(λ)=x(λ)+y(λ)+z(λ) (3)

In Expression (3), the weight function w (λ) is defined by adding color-matching functions x (λ), y (λ), and z (λ). By multiplying the entire right side of Expression (3) by a predetermined coefficient, a range of values of the weight function w (λ) may be normalized. According to Expression (1) described above, the color value (L*a*b* value) can be said to be considerably influenced, as the color-matching functions x (λ), y (λ), and z (λ) have a larger wavelength region. Accordingly, by using the weight function w (λ) obtained by adding the color-matching functions x (λ), y (λ), and z (λ), it is possible to obtain the evaluation value E (Φ) capable of evaluating a square error in which the large wavelength region, which has considerable influence on a color, is valued highly. For example, the weight function w (λ) is zero in a near-ultraviolet wavelength region which cannot be perceived by human eyes. Therefore, in the near-ultraviolet wavelength region, the difference D (λ) does not contribute to an increase in the evaluation value E (Φ).

That is, even though a difference between the target spectral reflectivity Rₜ (λ) or the mixed-color spectral reflectivity Rmix (λ) and the estimation spectral reflectivity Rₛ (λ) in the entire visible wavelength region is not small, it is possible to obtain the evaluation value E (Φ) having a small value, as long as the target spectral reflectivity Rₜ (λ) or the mixed-color spectral reflectivity Rmix (λ) and the estimation spectral reflectivity Rₛ (λ) are similar to each other in a wavelength region which is perceived strongly by human eyes. Moreover, the evaluation value E (Φ) can be used as an index of an approximate property of the spectral reflectivity R (λ) suitable for human eyes. The calculated evaluation value E (Φ) returns to the ICM P3a1. That is, when the ICM P3a1 outputs an arbitrary ink amount set Φ to the RPM P3a2 and ECM P3a3, a final evaluation value E (Φ) is configured to return to the ICM P3a1. The ICM P3a1 calculates an optimum solution of the ink amount set Φ in which an evaluation value E (Φ) as an object function is minimized, by repeatedly obtaining the evaluation value E (Φ) in correspondence with an arbitrary ink amount set Φ. As a method of calculating the optimum solution, various optimization methods can be used, but a non-linear optimization method called a gradient method can be used.

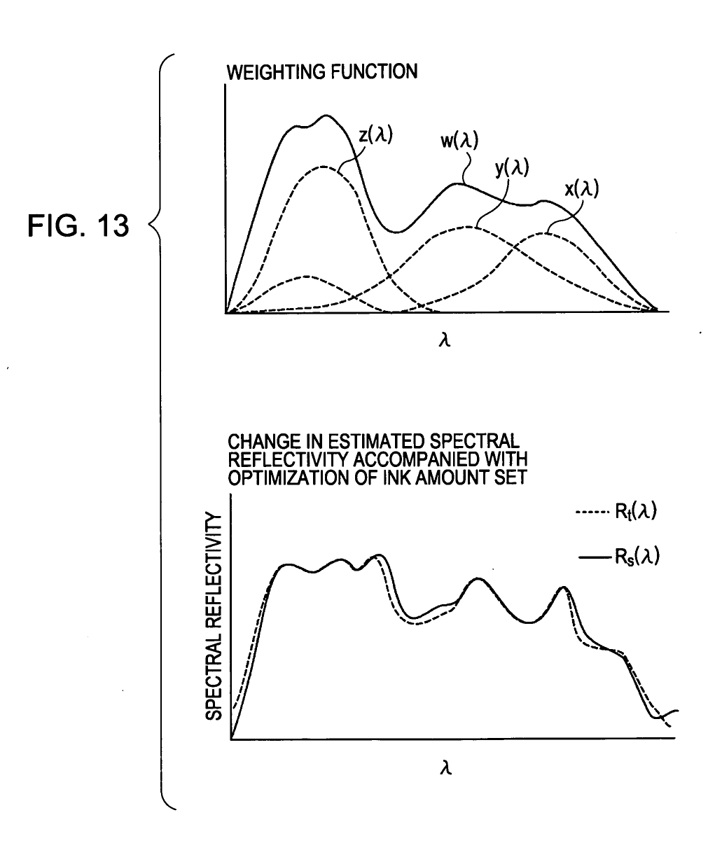

FIG. 13 is a schematic diagram illustrating optimization of the ink amount set Φ in Step S230. In the drawing, the estimation spectral reflectivity Rₛ (λ) obtained when printing is performed with the ink amount set Φapproximates to the target spectral reflectivity Rₜ (λ) or the mixed-color spectral reflectivity Rmix (λ), as the ink amount set Φ is optimized. Moreover, as the color-matching functions x (λ), y (λ), and z (λ) have a larger wavelength region by using the weight function w (λ), a restriction of the estimation spectral reflectivity Rₛ (λ) to the target spectral reflectivity Rₜ (λ) or the mixed-color spectral reflectivity Rmix (λ) becomes stronger and a difference between the estimation spectral reflectivity Rₛ (λ) and the target spectral reflectivity Rₜ (λ) or the mixed-color spectral reflectivity Rmix (λ) becomes smaller. Accordingly, since the estimation spectral reflectivity Rₛ (λ) is restricted to the target spectral reflectivity Rₜ (λ) or the mixed-color spectral reflectivity Rmix (λ) of the target TG firstly for the large wavelength region of the color-matching functions x (λ), y (λ), and z (λ) which has considerable influence on view, it is possible to calculate the ink amount set Φ apparently similar when an arbitrary light source is radiated. In this way, it is possible to calculate the ink amount set Φ capable of reproduction of an appearance similar to that of the target TG by printer 20 under any light source. In addition, a final condition of the optimization may be set to the repeated number of times of updating the ink amount set Φ or a threshold value of the evaluation value E (Φ).

In this way, when the ICM P3a1 calculates the ink amount set Φ capable of reproduction of the spectral reflectivity R (λ) having the same appearance as that of the target TG in Step S230, it is determined in Step S240 whether all the indexes described in the index table IDB are selected in Step S220. When all the indexes are not selected, the process returns to Step S220 to select a subsequent index. In this way, it is possible to calculate the ink amount sets Φ capable of reproduction of the same color of that of the target TG for all the indexes. That is, the ink amount sets Φ capable of reproduction of the spectral reflectivity R (λ), as in all targets TG1 to TG12, can be calculated for all targets TG1 to TG12 subjected to color measurement in Step S140 of the print data generating process (see FIG. 2). In Step S240, when it is determined that optimum ink amount sets Φ of all the indexes are calculated, the LOM P3a4 generates a 1D-LUT and outputs the 1D-LUT to the CDG P3b in Step S250.

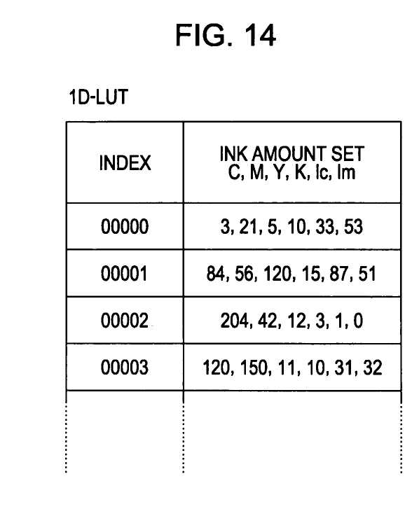

FIG. 14 is a diagram illustrating an example of the 1D-LUT. In the drawing, the optimum ink amount sets Φ individually corresponding to the indexes are stored. That is, in each of the targets TG1 to TG12, the 1D-LUT describing the ink amount set Φ capable of reproduction of the appearance similar to that of each of the targets TG1 to TG12 in the printer 20 can be prepared. When the 1D-LUT is output to the CDG P3b, the 1D-LUT generating process is completed and then the printing control data generating process (Step S300) as a subsequent process is performed.

As described above, the method of estimating the spectral reflectivity can be used as the same method as the method of estimating the mixed-color spectral reflectivity and the method of calculating the ink amount set for realizing the mixed-color spectral reflectivity. That is, in the estimation of the color material set for printing the mixed colors in the printer 20, the estimation of the spectral reflectivity is performed by repeatedly changing the use ratio of respective ink in the printer 20 by use of the same method in the method of calculating the mixed-color spectral reflectivity Rₘᵢₓ (λ) on the basis of the spectral reflectivity of each color material of the second color material group and the use ratio and the method of calculating the estimation spectral reflectivity Rₛ (λ) on the basis of the spectral reflectivity of each ink in the printer 20 and the use ratio of each ink, so that the estimation spectral reflectivity Rₛ (λ) is spectral reflectivity approximate to the mixed-color spectral reflectivity Rₘᵢₓ (λ). Whether the estimation spectral reflectivity Rₛ (λ) is approximate to the mixed-color spectral reflectivity Rₘᵢₓ (λ) may be evaluated by the above-described evaluation function or the like. By allowing the estimation method of the spectral reflectivity to be common, it is difficult for mismatch in the estimation of each spectral reflectivity to occur. Therefore, the estimation of the mixed colors is more suitable. In addition, since an algorithm used in the estimation method is common, the program size can be reduced.

### 4-2. Printing Control Data Generating Process

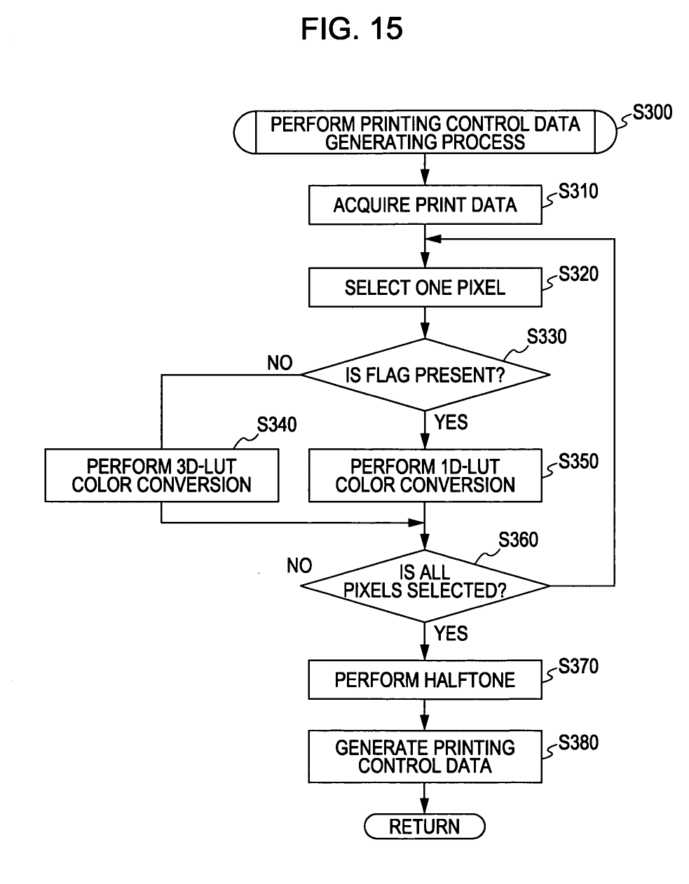

FIG. 15 is a flowchart illustrating a flow of the printing control data generating process. The CDG P3b shown in FIG. 2 includes a mode determining module (MIM) P3b1, an index converting module (ISM) P3b2, an RGB converting module (CSM) P3b3, a halftone module (HTM) P3b4, and a rasterization module (RTM) P3b5. In Step S310, the mode determining module (MIM) P3b1 acquires the print data PD. In Step S320, the MIM P3b1 selects one pixel from the print data PD. In Step S330, the MIM P3b1 determines whether the flag indicating that the index is stored in the selected pixel is set. When it is determined that the flag is not set, the CSM P3b3 performs color conversion (plate division) on the selected pixel with reference to the 3D-LUT in Step S340.

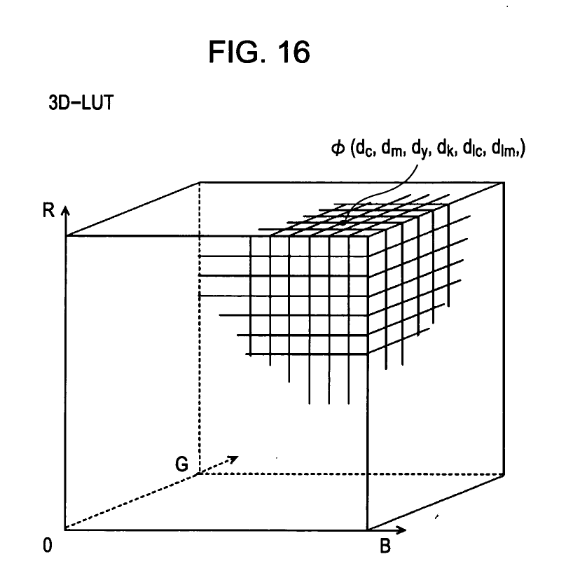

FIG. 16 is a diagram illustrating the 3D-LUT. In the drawing, the 3D-LUT is a table which describes a correspondence relation between the RGB values and the ink amount sets Φ (d_{C}, d_{M}, d_{Y}, d_{K}, d_{1c}, d₁ₘ) for plural representative coordinates in a color space. The CSM P3b3 acquires the ink amount set Φ corresponding to the RGB value of the corresponding pixel with reference to the 3D-LUT. At this time, the CSM P3b3 acquires the ink amount set Φ corresponding to the RGB value which is not directly described in the 3D-LUT, by performing interpolation calculation. As a method of creating the 3D-LUT, a method disclosed in JP-A-2006-82460 may be used. In this document, there is created the 3D-LUT which is overall good in a reproducibility of a color under a specific light source, a gray scale property of the reproduced color, a granularity, a light source independent property of the reproduced color, a gamut, or an ink duty.

Alternatively, when it is determined that the flag indicating that the index is stored in the selected pixel is set in Step S330, the ISM P3b2 performs the color conversion (plate division) on the selected pixel with reference to the 1D-LUT in Step S350. That is, the index is acquired from the pixel in which the flag indicating the index is stored, and the ink amount set Φ corresponding to the index is acquired from the 1D-LUT. When it is possible to acquire the ink amount set Φ for the selected pixel in one of Step S340 and Step S350, it is determined whether the ink amount sets Φ for all the pixels can be acquired in Step S360. Here, when the pixel in which the ink amount set Φ is not acquired remains, the process returns to Step S320 to select a subsequent pixel.

By repeatedly performing the above processes, it is possible to acquire the ink amount sets Φ for all the pixels. When it is possible to acquire the ink amount sets Φ for all the pixels, the converted print data PD in which the all the pixels are expressed by the ink amount sets Φ are obtained. By determining whether to use one of the 1D-LUT and the 3D-LUT for each of the pixels, as for the pixel corresponding to each of the frames F1 to F12 in which the index is stored, it is possible to acquire the ink amount set Φ capable of reproduction of a color close to that of each of the targets TG1 to TG12 under each light source. Moreover, as for the pixel in which the RGB value is stored, it is possible to acquire the ink amount set Φ capable of color reproduction which is based on a guide (for example, placing emphasis on the granularity) of creating the 3D-LUT.

In Step S370, the HTM P3b4 acquires the print data PD in which each of the pixels is expressed with the ink amount set Φ to perform a halftone process. The HTM P3b4 can use a known dither method or a known error diffusion method, when performing the halftone process. The print data PD subjected to the halftone process has an ejection signal indicating whether to eject each ink for each pixel. In Step S380, the RTM P3b5 acquires the print data PD subjected to the halftone process and perform a process of allocating the ejection signal of the print data PD to each scanning pass and each nozzle of a print head of the printer 20. In this way, the printing control data CD which can be output to the printer 20 is generated. In addition, the printing control data CD attached to a signal necessary to control the printer 20 is output to the spooler P1b and the printer 20. Then, the printer 20 ejects the ink onto a print sheet to form the sample chart SC.

In this way, it is possible to reproduce the target spectral reflectivity Rₜ (λ) or the mixed-color spectral reflectivity Rmix (λ) of each of the targets TG1 to TG12 in the areas corresponding to the frames FL1 to FL12 of the sample chart SC formed on the print sheet. That is, since the area corresponding to the frames FL1 to FL12 is printed with the ink amount sets Φ suitable for the colors of the targets TG1 to TG12 under the plural light sources, it is possible to reproduce colors similar to those of the targets TG1 to TG12 under each of the light sources. For example, the colors of the areas corresponding to the frames FL1 to FL12 when the sample chart SC is viewed indoors are reproduced into the colors when the targets TG1 to TG12 are viewed indoors. In addition, the colors of the areas corresponding to the frames FL1 to FL12 when the sample chart SC is viewed outdoors are also reproduced into the colors when the targets TG1 to TG12 are viewed outdoors.

Ultimately, when the sample chart SC having the completely same spectral reflectivity R (λ) as that of the targets TG1 to TG12 or the spectral reflectivity which is the completely same spectral reflectivity of the estimated mixed-color is reproduced, it is possible to reproduce the same colors as those of the targets TG1 to TG12 or the print result obtained by actually mixing the colors under any light source. However, since the ink (kinds of a color material) usable for the printer 20 is restricted to CMYKlclm, it is impossible to actually obtain the ink amount sets Φ capable of reproduction of the completely same spectral reflectivity R (λ). In addition, even when the ink amount sets Φ capable of reproduction of the same spectral reflectivity R (λ) are obtained in a wavelength region which does not affect a perceived color, it is not useless in realization of a visual reproduction degree. In contrast, in the invention, since an approximation to the target spectral reflectivity Rₜ (λ) or the estimated mixed color is evaluated using the evaluation value E (Φ) to which a weight based on the color-matching functions x (λ), y (λ), and z (λ) is added, it is possible to obtain the ink amount set Φ realized sufficiently in terms of visibility.

In the areas corresponding to the frames FL1 to FL12 of the sample chart SC formed on the print sheet or the area to be printed with the mixed colors, printing is performed with the ink amount sets Φ which are based on the 3D-LUT described above. Therefore, a printing performance in the areas is based on the 3D-LUT. As described above, the area other than the areas corresponding to the frames FL1 to FL12 or the area to be printed with the mixed colors in this embodiment is indicated by the image of the intermediate gray, but satisfies the printing performance which is a goal of the 3D-LUT in the areas. That is, it is possible to perform printing so as overall satisfy a gray scale property of the reproduced color, a granularity, a light source independent property of the reproduced color, a gamut, and an ink duty.

### 5. Spectral Printing Model

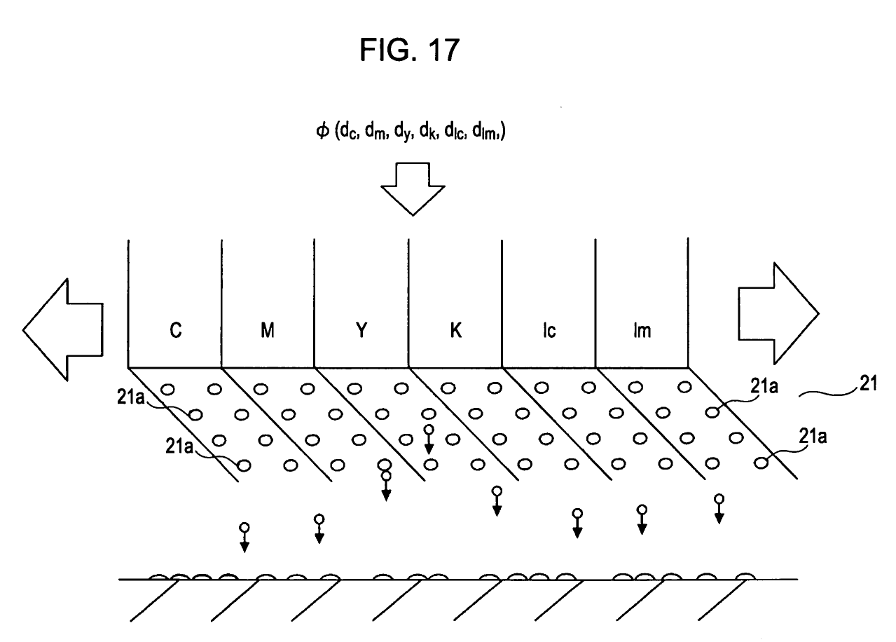

FIG. 17 is a schematic process illustrating a printing method of the printer 20 according to this embodiment. In the drawing, the printer 20 includes a print head 21 having plural nozzles 21a for each of CMYKlclm ink and an amount of each of CMYKlclm ink ejected from the nozzles 21a is controlled to become an amount of ink designated in the ink amount set Φ (d_{c}, dₘ, d_{y}, dₖ, d_{1c}, d₁ₘ) on the basis of the printing control data CD. Ink droplets ejected from the nozzles 21a turn to minute dots on the print sheet and a print image of ink coverage conforming to the ink amount set Φ (d_{c}, dₘ, d_{y}, dₖ, d_{1c}, d₁ₘ) is formed on the print sheet by collection of the numerous dots.

The estimation model (spectral printing model) used by the RPM P3a2 is an estimation model used to estimate the spectral reflectivity R (λ) obtained upon performing printing with an arbitrary ink amount set Φ (d_{c}, dₘ, d_{y}, dₖ, d_{1c}, d₁ₘ) used in the printer 20 according to this embodiment as the estimation spectral reflectivity Rₛ (λ). In the spectral printing model, a color patch is actually printed for plural representative points in an ink amount space, and the spectral reflectivity database RDB obtained by measuring the spectral reflectivity R (λ) by use of the spectral reflectometer is created. The spectral reflectivity R (λ) obtained upon precisely performing printing with the arbitrary ink amount set Φ (d_{c}, dₘ, d_{y}, dₖ, d_{1c}, d₁ₘ) is estimated by the Cellular Yule-Nielsen Spectral Neugebauer Model using the spectral reflectivity database RDB.

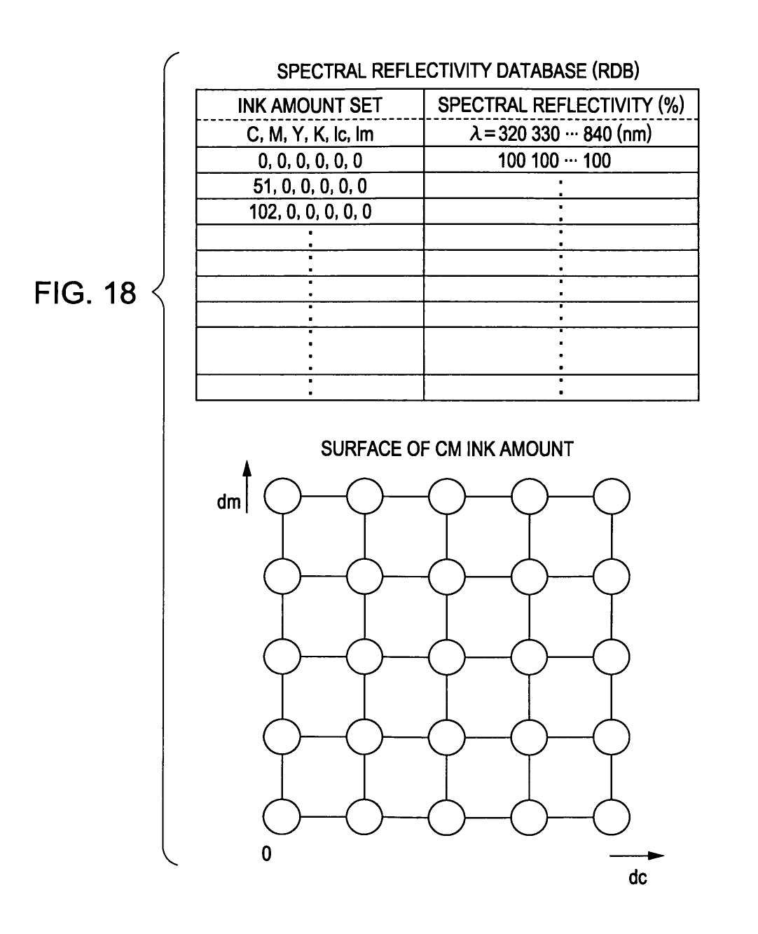

FIG. 18 is a diagram illustrating the spectral reflectivity database RDB. As shown in the drawing, the spectral reflectivity database RDB is configured as a lookup table which describes the spectral reflectivity R (λ) obtained by actually printing/measuring each of the ink amount sets Φ (d_{c}, dₘ, d_{y}, dₖ, d_{1c}, d₁ₘ) of plural lattice points in the ink amount space (which is a six-dimensional space, but in this embodiment, only a CM surface is illustrated for simplification of the drawing). For example, lattice points of five grids dividing ink amount axes are generated. Here, 5¹³ lattice points are generated and it is necessary to print/measure an enormous amount of color patches. However, actually, since the number of ink simultaneously mounted on the printer 20 or ink duty capable of simultaneous ejection is restrictive, the number of lattice points to be printed/measured is limited.

Only some lattice points may be actually printed/measured. In addition, as for the other lattice points, the number of color patches to be actually printed/measured may be decreased by estimating the spectral reflectivity R (λ) on the basis of the spectral reflectivity R (λ) of the lattice points actually subjected to printing/measuring. The spectral reflectivity database RDB needs to be created for every print sheet to be printed by the printer 20. Precisely, the reason is because the spectral reflectivity R (λ) is determined depending on the spectral reflectivity made by an ink film (dot) formed on a print sheet and reflectivity of the print sheet and receives a great influence of a surface property (on which a dot formation is dependent) or the reflectivity of the print sheet. Next, estimation obtained by the Cellular Yule-Nielsen Spectral Neugebauer Model using the spectral reflectivity database RDB will be described.

The RPM P3a2 performs the estimation by use of the Cellular Yule-Nielsen Spectral Neugebauer Model using the spectral reflectivity database RDB by request of the ICM P3a1. In the estimation, an estimation condition is acquired from the ICM P3a1 and the estimation condition is set. Specifically, the print sheet or the ink amount set Φ is set as a print condition. For example, when a glossy sheet is set as the print sheet for performing the estimation, the spectral reflectivity database RDB created by printing the color patch on the glossy sheet is set.

When the spectral reflectivity database RDB can be set, the ink amount sets Φ (d_{c}, dₘ, d_{y}, dₖ, d_{1c}, d₁ₘ) input from the ICM P3a1 is applied to the spectral printing model. The Cellular Yule-Nielsen Spectral Neugebauer Model is based on well-known Spectral Neugebauer Model and Yule-Nielsen Model.

In the following description, a model in which three kinds of CMY ink are used for easy description will be described, but it is easy to expand the same model to a model using an arbitrary ink set including the CMYKlclm ink according to this embodiment. The Cellular Yule-Nielsen Spectral Neugebauer Model is referred to Color Res Appl 25, 4-19, 2000 and R Balasubramanian, Optimization of the spectral Neugegauer model for printer characterization, J. Electronic Imaging 8 (2), 156-166 (1999).

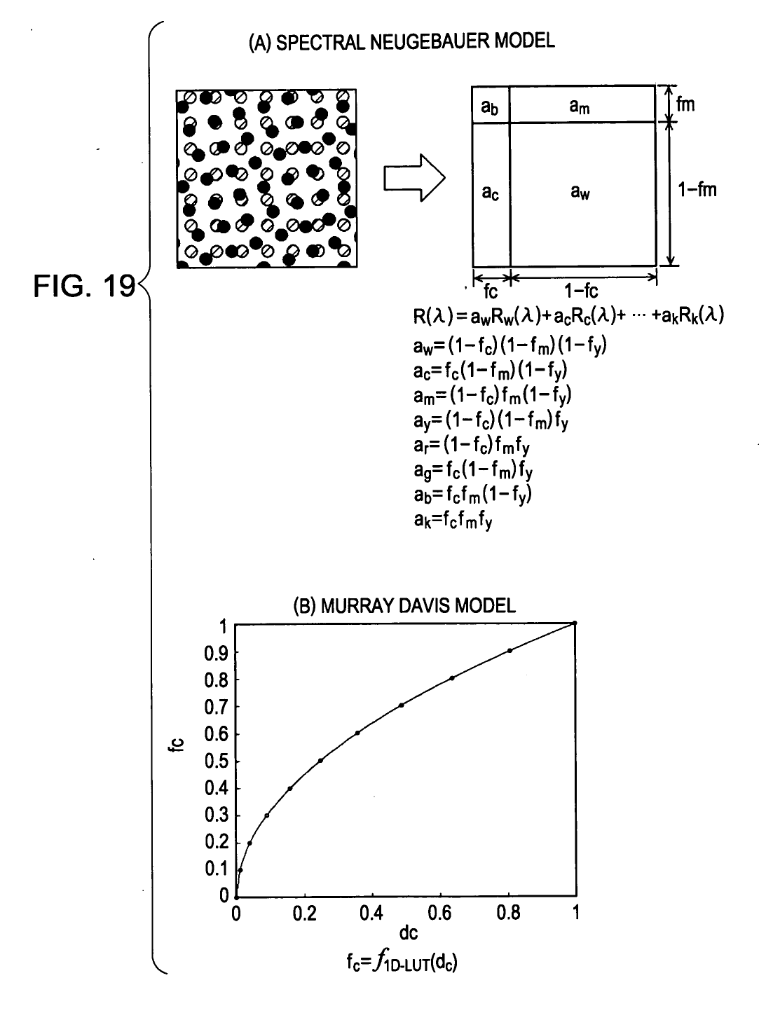

FIG. 19 is a diagram illustrating the Spectral Neugebauer Model. In the Spectral Neugebauer Model, the estimation spectral reflectivity Rₛ (λ) of a sheet printed with an arbitrary ink amount set (d_{c}, dₘ, d_{y}) is given by Expression (4) as follows:

$$\begin{matrix}[ Expression 4 ] & \\ {R}_{s} ( λ ) = {a}_{w} {R}_{w} ( λ ) + {a}_{c} {R}_{c} ( λ ) + {a}_{m} {R}_{m} ( λ ) + {a}_{y} {R}_{y} ( λ ) + {a}_{r} {R}_{r} ( λ ) + {a}_{g} {R}_{g} ( λ ) + {a}_{b} {R}_{b} ( λ ) + {a}_{k} {R}_{k} ( λ ) \\ {a}_{w} = ( 1 - {f}_{c } ) ( 1 - {f}_{m} ) ( 1 - {f}_{y} ) \\ {a}_{c} = {f}_{c} ( 1 - {f}_{m} ) ( 1 - {f}_{y} ) \\ {a}_{m} = ( 1 - {f}_{c} ) {f}_{m} ( 1 - {f}_{y} ) \\ {a}_{y} = ( 1 - {f}_{c} ) ( 1 - {f}_{m} ) {f}_{y} \\ {a}_{r} = ( 1 - {f}_{c} ) {f}_{m} {f}_{y} \\ {a}_{g} = {f}_{c} ( 1 - {f}_{m} ) {f}_{y} \\ {a}_{b} = {f}_{c} {f}_{m} ( 1 - {f}_{y} ) \\ {a}_{k} = {f}_{c} {f}_{m} {f}_{y} . & ( 4 )\end{matrix}$$

In this expression, aᵢ is an i-th area ratio and Rᵢ (λ) is an i-th spectral reflectivity. The subscript i each indicates an area (w) in which ink is not present, an area (c) in which only cyan ink is ejected, an area (m) in which only magenta ink is ejected, an area (y) in which only yellow ink is ejected, an area (r) in which magenta ink and yellow ink are ejected, an area (g) in which yellow ink and cyan ink are ejected, an area (b) in which cyan ink and magenta ink are ejected, and an area (k) in which three CMY kinds of ink are ejected. In addition, each of f_{c}, fₘ, and f_{y} indicates a ratio (which is referred to as “an ink area coverage”) of an area covered with only one kind of ink among CMY ink at the time of ejection.

The ink area coverages f_{c}, fₘ, and f_{y} are given by the Murray Davis Model shown in (B) of FIG. 19. In the Murray Davis Model, the ink area coverage f_{c} of cyan ink is a non-linear function of an ink amount d, of cyan, for example. The ink amount d_{c} can be converted into the ink area coverage f_{c} with reference to a one-dimensional lookup table, for example. The reason that the ink area coverages f_{c}, fₘ, and f_{y} are non-linear functions of the d_{c}, dₘ, and d_{y} is that since ink sufficiently spreads upon ejecting a small amount of ink onto a unit area but ink overlaps with each other upon ejecting a large amount of ink onto the unit area, an area covered with the ink does not increase sufficiently. The same is applied to the other kinds of MY ink.

When the Yule-Nielsen Model for the spectral reflectivity is applied, Expression (4) described above can be changed into Expression (5a) or Expression (5b) as follows:

$$\begin{matrix}[ Expression 5 ] & \\ {{R}_{s} ( λ )}^{1 / n} = {a}_{w} {{R}_{w} ( λ )}^{1 / n} + {a}_{c} {{R}_{c} ( λ )}^{1 / n} + {a}_{m} {{R}_{m} ( λ )}^{1 / n} + {a}_{y} {{R}_{y} ( λ )}^{1 / n} + {a}_{r} {{R}_{r} ( λ )}^{1 / n} + {a}_{g} {{R}_{g} ( λ )}^{1 / n} + {a}_{b} {{R}_{b} ( λ )}^{1 / n} + {a}_{k} {{R}_{k} ( λ )}^{1 / n} & ( 5 a ) \\ {R}_{s} ( λ ) = {\{ \begin{matrix}{a}_{w} {{R}_{w} ( λ )}^{1 / n} + {a}_{c} {{R}_{c} ( λ )}^{1 / n} + {a}_{m} {{R}_{m} ( λ )}^{1 / n} + {a}_{y} {{R}_{y} ( λ )}^{1 / n} + \\ {a}_{r} {{R}_{r} ( λ )}^{1 / n} + {a}_{g} {{R}_{g} ( λ )}^{1 / n} + {a}_{b} {{R}_{b} ( λ )}^{1 / n} + {a}_{k} {{R}_{k} ( λ )}^{1 / n}\end{matrix} \}}^{n} , & ( 5 b )\end{matrix}$$

where n is a predetermined coefficient of 1 or more and n=10 may be set, for example. Expression (5a) or Expression (5b) is an expression expressing the Yule-Nielsen Spectral Neugebauer Model.

The Cellular Yule-Nielsen Spectral Neugebauer Model is a model in which the ink amount space of the Yule-Nielsen Spectral Neugebauer Model described above is divided into plural cells.

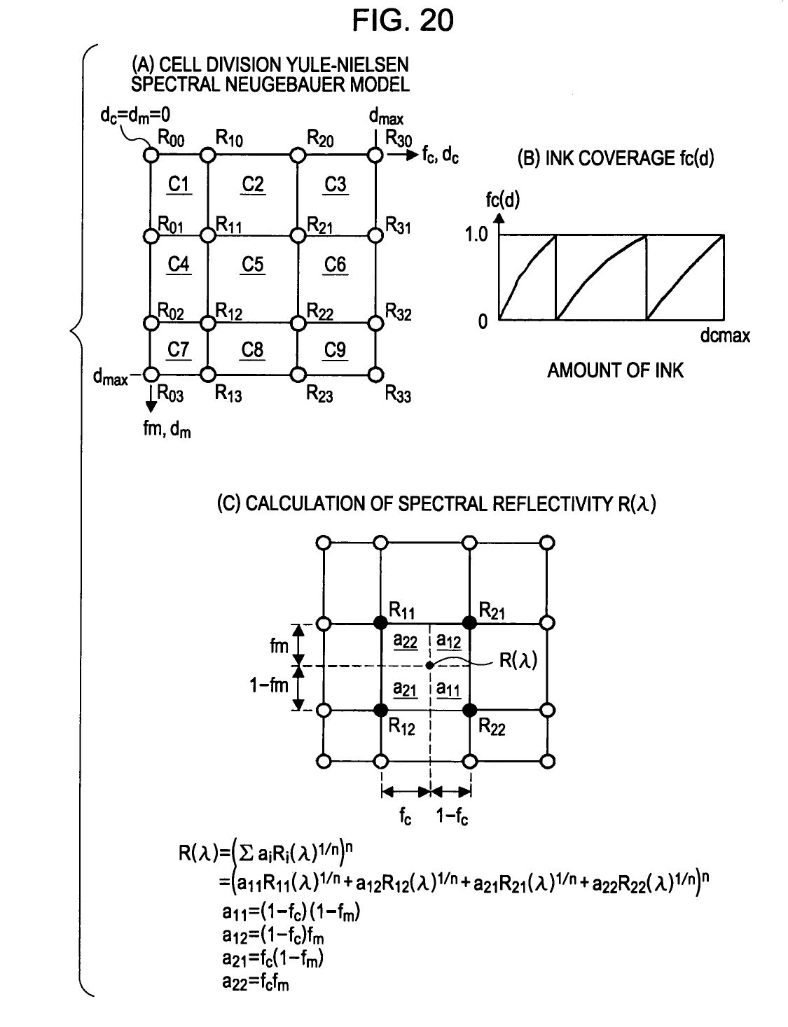

(A) of FIG. 20 is a diagram illustrating an example of a cell division in the Cellular Yule-Nielsen Spectral Neugebauer Model. Here, for easy description, the cell division is drawn in a two-dimensional ink amount space containing two axes of the ink amounts d_{c} and dₘ of CM ink. Since the ink area coverages f_{c} and fₘ have a unique relation with the ink amounts d_{c} and dₘ, respectively, in the Murray Davis Model described above, the axes can be considered to be axes indicating the ink area coverages f_{c} and fₘ. White circles indicate grid points (called lattice points) of the cell division and the two-dimensional ink amount (area coverage) space is divided into nine cells C1 to C9. Ink amount sets (d_{c}, dₘ) individually corresponding to the lattice points are configured as ink amount sets corresponding to the lattice points defined in the spectral reflectivity database RDB. That is, with reference to the spectral reflectivity database RDB described above, the spectral reflectivity R (λ) of each of the lattice points can be obtained. Accordingly, the spectral reflectivities R (λ)₀₀, R (λ)₁₀, R (λ)₂₀, . . . R (λ)₃₃ of the lattice points can be obtained from the spectral reflectivity database RDB.

Actually, in this embodiment, the cell division is also performed in the six-dimensional ink amount space of the CMYKlclm ink and coordinates of the lattice points are represented by the six-dimensional ink amount sets Φ (d_{c}, dₘ, d_{y}, dₖ, d_{1c}, d₁ₘ). In addition, the spectral reflectivity R (λ) of each of the lattice points corresponding to the ink amount set Φ (d_{c}, dₘ, d_{y}, dₖ, d_{1c}, d₁ₘ) of each of the lattice points is obtained from the spectral reflectivity database RDB (which is a database of a glossy sheet, for example).

(B) of FIG. 20 is a diagram illustrating a relation between the ink area coverage f_{c} and the ink amount d_{c} used in a cell division model. Here, a range from 0 to d_{cmax} in an amount of one kind of ink is divided into three sections. In addition, an imaginary ink area coverage f_{c} used in the cell division model is obtained by a non-linear curve which shows a monotonous increase from 0 to 1 in every section. The ink area coverages fₘ and f_{y} of the other ink are obtained in the same manner.

(C) of FIG. 20 is a diagram illustrating a method of calculating the estimation spectral reflectivity Rₛ (λ) obtained when printing is performed with an arbitrary ink amount set (d_{c}, dₘ) within a cell C5 located at the center of (A) of FIG. 20. The spectral reflectivity R (λ) obtained when printing is performed with an arbitrary ink amount set (d_{c}, dₘ) is given by Expression (6) as follows:

$$\begin{matrix}[ Expression 6 ] & \\ \begin{matrix}{R}_{s} ( λ ) = {( \sum {a}_{i} {{R}_{i} ( λ )}^{1 / n} )}^{n} \\ = ( {a}_{11} {{R}_{11} ( λ )}^{1 / n} + {a}_{12} {{R}_{12} ( λ )}^{1 / n} + {a}_{21} {{R}_{21} ( λ )}^{1 / n} + \\ { {a}_{22} {{R}_{22} ( λ )}^{1 / n} )}^{n}\end{matrix} \\ {a}_{11} = ( 1 - {f}_{c} ) ( 1 - {f}_{m} ) \\ {a}_{12} = ( 1 - {f}_{c} ) {f}_{m} \\ {a}_{21} = {f}_{c} ( 1 - {f}_{m} ) \\ {a}_{22} = {f}_{c} {f}_{m} . & ( 6 )\end{matrix}$$

In this expression, the ink area coverages f_{c} and fₘ in Expression (6) are values given in the graph of (B) of FIG. 20. Spectral reflectivities R (λ)₁₁, (λ)₁₂, (λ)₂₁, and (λ)₂₂ corresponding to four lattice points surrounding the cell C5 can be obtained with reference to the spectral reflectivity database RDB. In this way, all values of a right side of Expression (6) can be decided. In addition, as a calculation result, the estimation spectral reflectivity Rₛ (λ) obtained when printing is performed with the arbitrary ink amount set Φ (d_{c}, dₘ) can be calculated. By shifting a wavelength λ in sequence in the visible wavelength region, it is possible to obtain the estimation spectral reflectivity Rₛ (λ) in the visible wavelength region. When the ink amount space is divided into the plural cells, the estimation spectral reflectivity Rₛ (λ) can be calculated more precisely, compared to a case where the ink amount space is not divided. In this way, the RPM P3a2 is capable of estimating the estimation spectral reflectivity Rₛ (λ) by request of the ICM P3a1.

### 6. Modified Examples

### 6-1. Modified Example 1

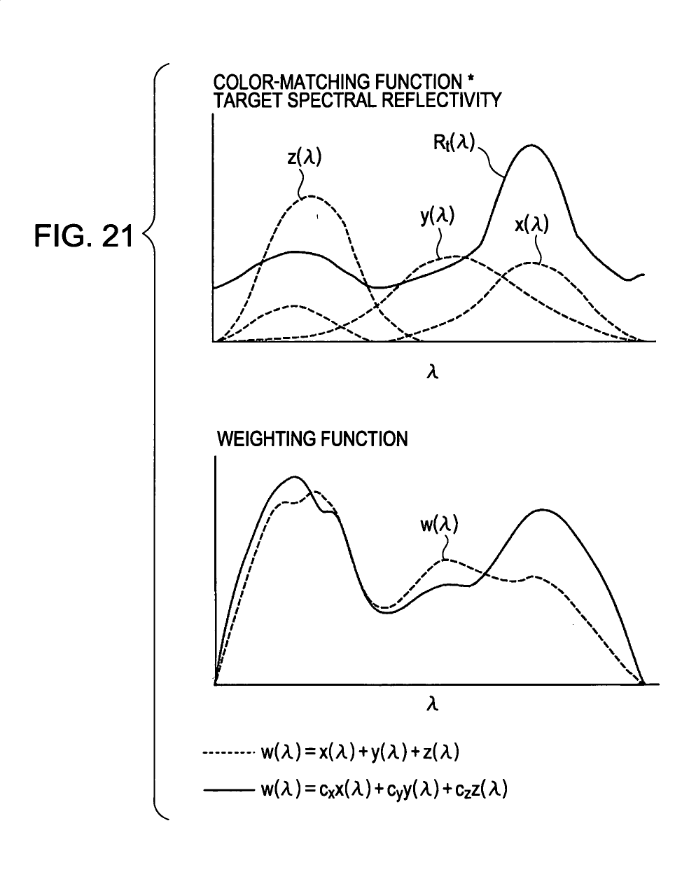

In modified examples described below, the target spectral reflectivity Rₜ (λ) is described as an example, but the same is applied to the mixed-color spectral reflectivity Rmix (λ). FIG. 21 is a schematic diagram illustrating a weight function w (λ) set by the ECM P3a3 according to a modified example. In the drawing, a target spectral reflectivity Rₜ (λ) obtained form a target TG is shown. In addition, the ECM P3a3 calculates each of correlation coefficients cₓ, c_{y}, and c_{z} between each of color-matching functions x (λ), y (λ), and z (λ) and the target spectral reflectivity Rₜ (λ). In addition, the weight function w (λ) is calculated by Expression (7) according to this modified example:

[Expression 7].

w(λ)=cₓx(λ)+c_{y}y(λ)+c_{z}z(λ) (7)

In Expression (7), a weight at the time of linear combination is configured to increase by the color-matching functions x (λ), y (λ), and z (λ) having high correlation with the target spectral reflectivity Rₜ (λ) obtained from the target TG. In the weight function w (X) obtained in this manner, a weight for a wavelength region having the large target spectral reflectivity Rₜ (λ) of the target TG can be emphasized. Accordingly, it is possible to obtain the evaluation value E (Φ) placing emphasis on a wavelength in which a spectrum of a spectral energy of reflected light under each light source becomes easily strong. That is, particularly, in the wavelength region having the large target spectral reflectivity Rₜ (λ) of the target TG, it is possible to obtain an optimum solution of the ink amount set Φ in which a difference between the target spectral reflectivity Rₜ (λ) and the estimation spectral reflectivity Rₛ (λ) of the target TG is not permitted. Of course, since the weight function w (λ) is obtained from each of the color-matching functions x (λ), y (λ), and z (λ), the evaluation value E (Φ) suitable for human perception can be obtained.

### 6-2. Modified Example 2

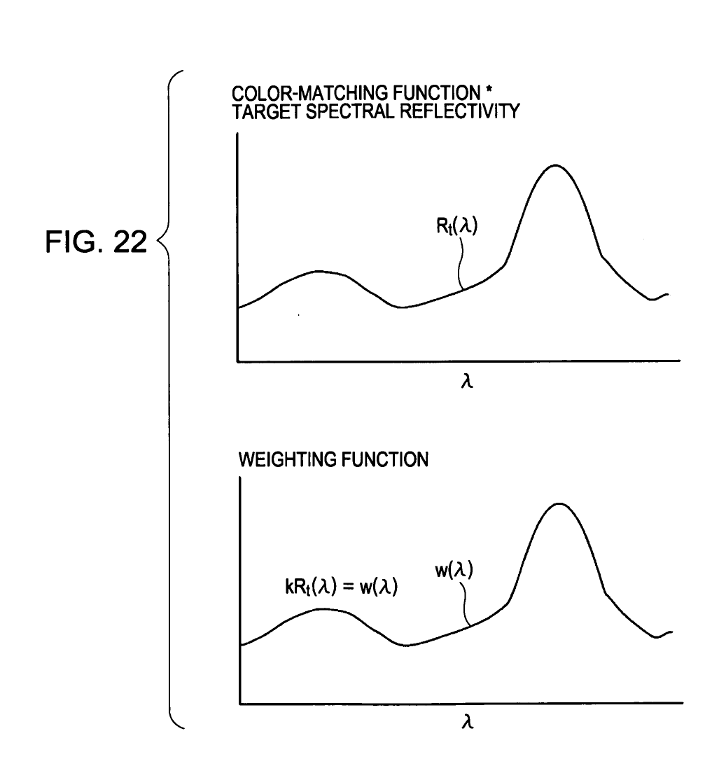

FIG. 22 is a schematic diagram illustrating a weight function w (λ) set by the ECM P3a3 according to another modified example. In the drawing, the target spectral reflectivity Rₜ (λ) obtained from the target TG is applied to the weight function w (λ) without any change. In this way, particularly, in the wavelength region having the large target spectral reflectivity Rₜ (λ) of the target TG, it is possible to also obtain an optimum solution of the ink amount set Φ in which a difference between the target spectral reflectivity Rₜ (λ) and the spectral reflectivity R (λ) of the target TG is not permitted.

### 6-3. Modified Example 3

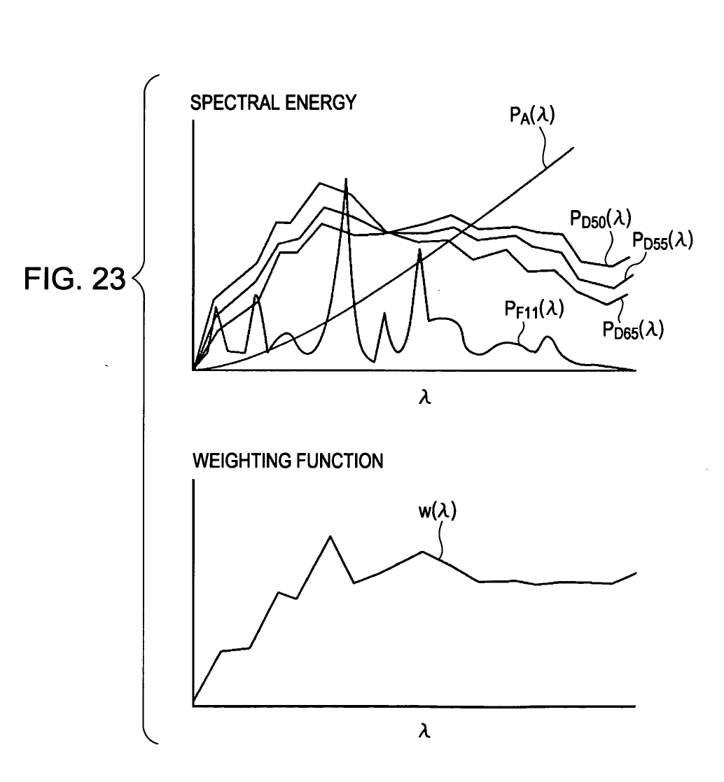

FIG. 23 is a schematic diagram illustrating a weight function w (λ) set by the ECM P3a3 according to another modified example. The drawing shows spectral energies P_{D50} (λ), P_{D55} (λ), P_{D65} (λ), P_{A} (λ), and P_{F11} (λ) of five kinds of light sources (a D50 light source, a D55 light source, and a D65 light sources of a standard daylight system, an A light source of an incandescent lamp system, and an F11 light source of a fluorescent lamp system). In this modified example, a weight function w (λ) is calculated by linear combination of the spectral energies P_{D50} (λ), P_{D55} (λ), P_{D65} (λ), P_{A} (λ), and P_{F11} (λ) by Expression (8) as follows:

[Expression 8].

w(λ)=w₁P_{D50}(λ)+w₂P_{D60}(λ)+w₃P_{D65}(λ)+w₄P_{A}(λ)w₅P_{F11}(λ) (8)

In Expression (8), w₁ to w₅ are weight coefficients used to set a weight for each of the light sources. In this way, by setting the weight function w (λ) obtained from the spectral energy distributions P_{D50} (λ), P_{D55} (λ), P_{D65} (λ), P_{A} (λ), and P_{F11} (λ) of the light sources, it is possible to obtain the evaluation value E (Φ) placing emphasis on the wavelength region in which a spectrum of a spectral energy of reflected light under each light source becomes easily strong. Moreover, it is possible to also adjust weight coefficients w₁ to w₅. For example, when it is desired to ensure color reproduction in all the light sources in balance, a relation of w₁=w₂=w₃=w₄=w₅ is satisfied. When it is desired to place emphasis on the color reproduction under an artificial light source, a relation of w₁, w₂, w₃<w₄, w₅ is satisfied.

### 6-4. Modified Example 4

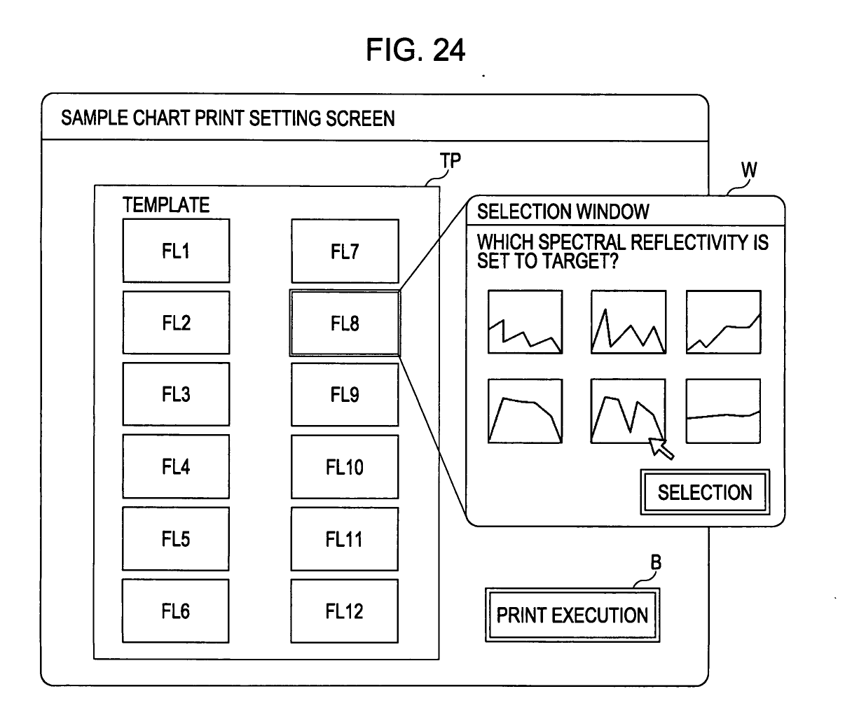

FIG. 24 is a diagram illustrating a UI screen displayed on the display 40 according to a modified example. In the drawing, graphs of plural target spectral reflectivities Rₜ (λ) are displayed on the UI screen. By displaying this UI screen, a user can selects a graph having a desired waveform as the target spectral reflectivity Rₜ (λ) of the target TG, instead of measuring the target spectral reflectivity Rₜ (λ) of the target TG in Step S140. In this way, it is possible to set the target spectral reflectivity Rₜ (λ) without actual measurement of the spectral reflectivity. Of course, the user may directly edit the waveform of the graph. For example, once the target spectral reflectivity Rₜ (λ) which is a target upon developing a new object surface is edited, it is possible to allow the printer 20 to print the sample chart SC having the target spectral reflectivity Rₜ (λ) which is a target without actually experimental manufacture of the object surface. In this way, the graph having the desired wavelength can be used in the sample color which is the foundation of the mixed color. In addition, a color mixed with the spectral reflectivity expressed in the desired graph can be also estimated.

### 6-5. Modified Example 5

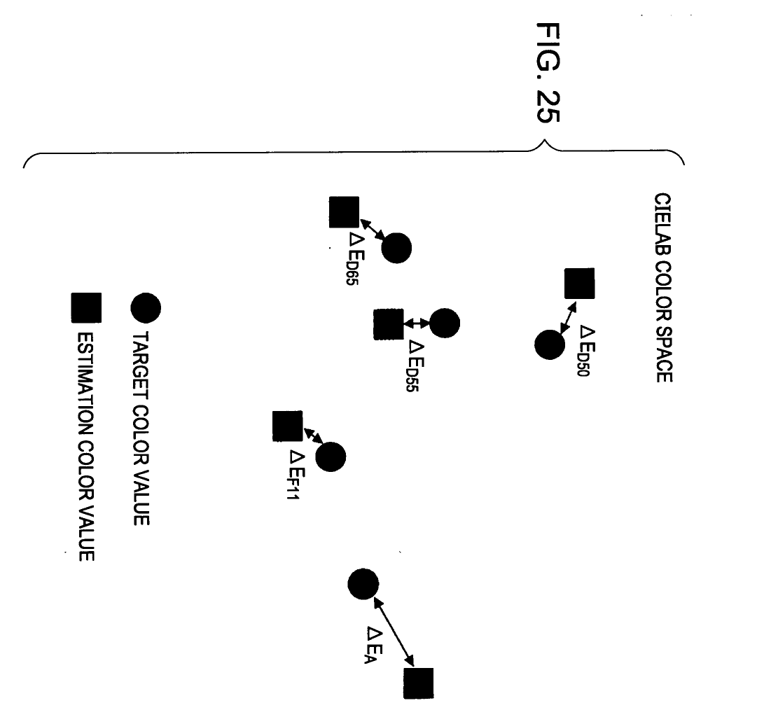

FIG. 25 is a diagram schematically illustrating an evaluation value (Φ) according to a modified example. In the drawing, a color value (target color value) obtained upon radiating the above-described five kinds of light sources in the target spectral reflectivity Rₜ (λ) of the target TG is calculated by use of Expression (1) described above in FIG. 5. On the other hand, a color value (estimation color value) obtained upon radiating the five kinds of light sources in the estimation spectral reflectivity Rₛ (λ) estimated by the RPM P3a2 is also calculated by Expression (1) (which is used by replacement of Rₜ (λ) by Rₛ (Φ)) described above in FIG. 5. In addition, a color difference ΔE (ΔE₂₀₀₀) of the target color value and the estimation color value under each of the light sources is calculated on the basis of a color difference expression of a CIE DE 2000. When it is assumed that color differences ΔE for the light sources are ΔE_{D50}, ΔE_{D55}, ΔE_{D65}, ΔE_{A}, and ΔE_{F11}, respectively, the evaluation value E (Φ) is calculated by Expression (9):

[Expression 9].

E(Φ)=w₁ΔE_{D50}+w₂ΔE_{D60}+w₃ΔE_{D65}+w₄ΔE_{A}+w₅ΔE_{F11} (9)

In Expression (2), w₁ to w₅ are weight coefficients used to set a weight for each of the light sources and has the substantially same property as that of the weight coefficients w₁ to w₅ described in Modified Example 3. Here, when it is desired to ensure color reproduction in all the light sources in balance, a relation of w₁=w₂=w₃=w₄=w₅ is satisfied. When it is desired to place emphasis on the color reproduction under an artificial light source, a relation of w₁, w₂, w₃<w₄, w₅ is satisfied.

### 6-6. Modified Example 6

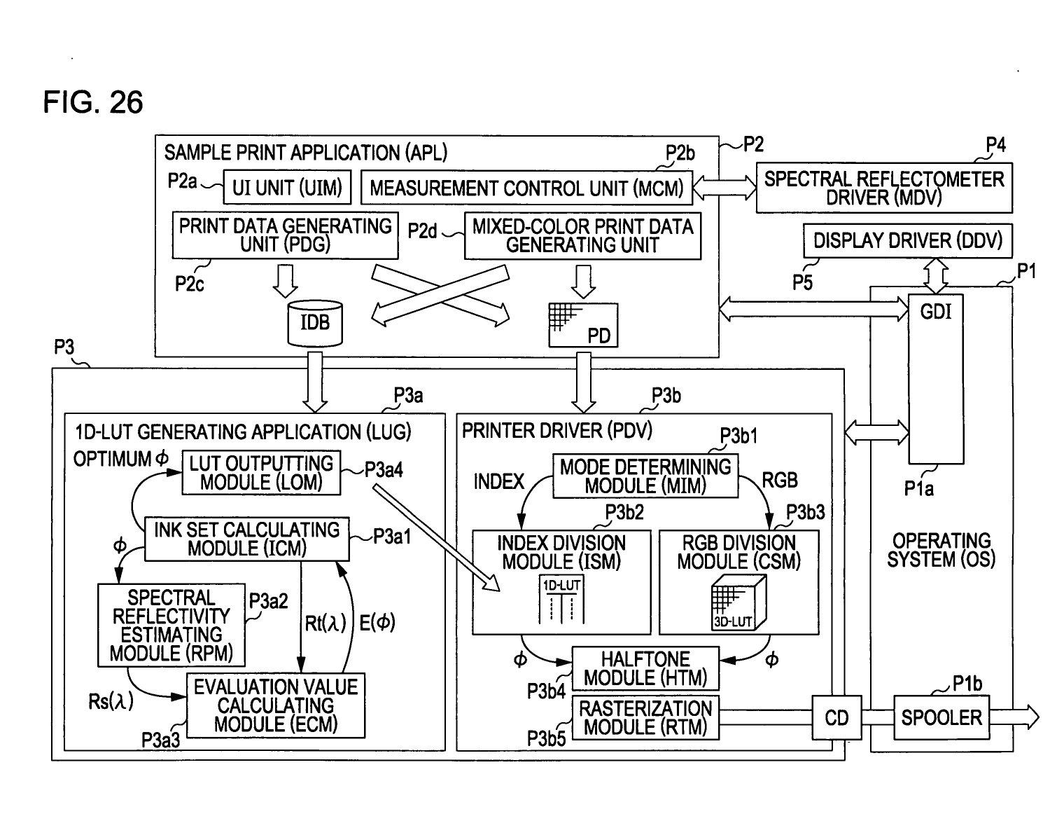

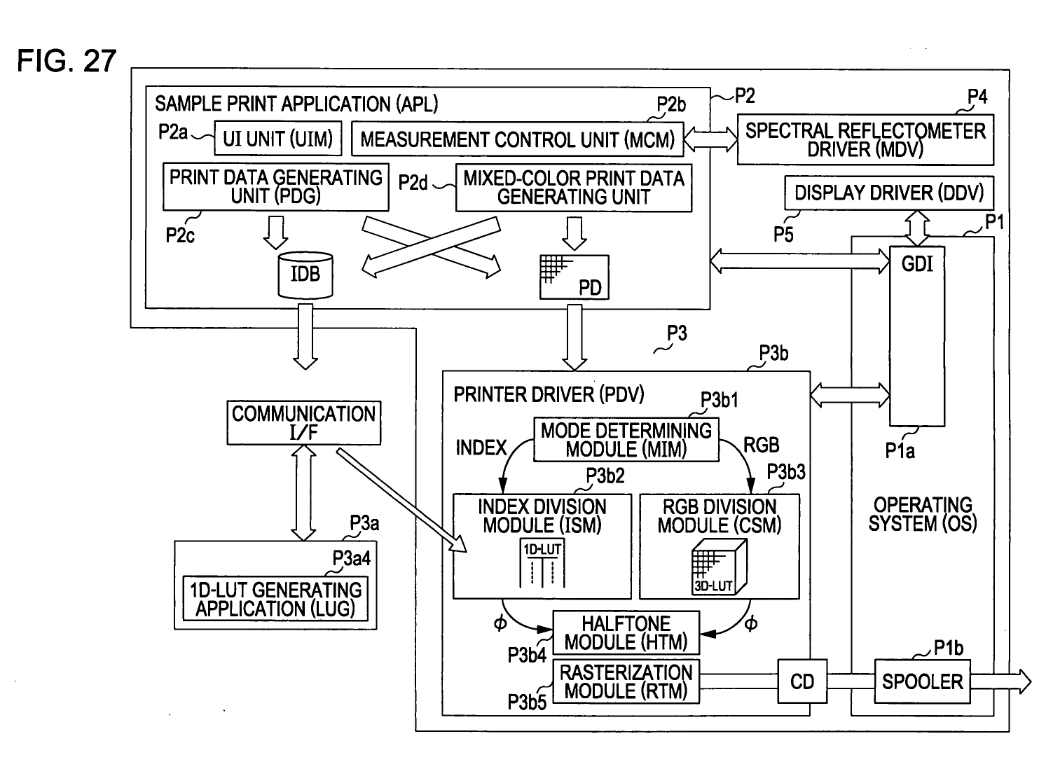

FIGS. 26 and 27 are diagrams illustrating the software configuration of a printing system according to a modified example of the invention. As shown in FIG. 24, a configuration corresponding to the LUG P3a in the embodiment described above may be provided as an internal module (1D-LUT creating unit) of the PDV P3b. As shown in FIG. 27, a configuration corresponding to the LUG P3a in the embodiment described above may be executed in another computer 110. In this case, the computer 10 and the computer 110 are connected to each other through a predetermined communication interface CIF. A 1D-LUT generated in an LUG P3a of the computer 110 is transmitted to the computer 10 through the communication interface CIF. The communication interface CIF may be configured via the Internet. In this case, the computer 10 can perform the color conversion with reference to the 1D-LUT acquired from the computer 110 on the Internet. In addition, in the printer 20, the whole software configuration of P1 to P5 may be executed. Of course, even when a hardware configuration executing the same processes of those of the software configuration of P1 to P5 is added to the printer 20, the invention can be realized.

### 6-7. Modified Example 7

In the embodiment described above, the UI on which the plural colors are designated to display the mixed color of the plural colors has been described, but the mixed color estimating method described above can be also used to reproduce a color (target color) desired by a user. For example, suppose a case where a color sample (representative color) which the target color can express in an ink set regardless of imaging the color (target color) desired by the user is not present and a print or the like having the target color is not present. In this case, when the user has an actual object or data which does not have the target color but has a color similar to the target color or when the user has information necessary to designate the similar color, the target color can be searched by using the similar color as an index (guide) color.

More specifically, when combination of color samples for mixing colors to reproduce a color (target color TC) being imaged by a user is researched, designation of a color (index color IC) similar to the target color TC is received from the user and color material combination and a color mixture ratio necessary to reproduce the index color IC is calculated. The index color IC reproduced in this manner is the color similar to the target color TC. By changing the color mixture ratio of the color material combination in the index color IC, it is possible to calculate the color mixture ratio for reproducing a color closer to the target color TC. Accordingly, when a unit for changing the color mixture ratio of the index color IC and a unit for displaying a color having the changed color mixture ratio are provided for the user, the color closest to the target color TC and desired by the user can be reproduced while the user changes the color mixture ratio with reference to the index color IC. That is, when a freedom for changing the color mixture ratio is given to the user, the user can search the color materials reproducing the color close to the target color TC according to the sensibility of the user. Hereinafter, a case where some colors of the image data are used as the index color IC will be described.

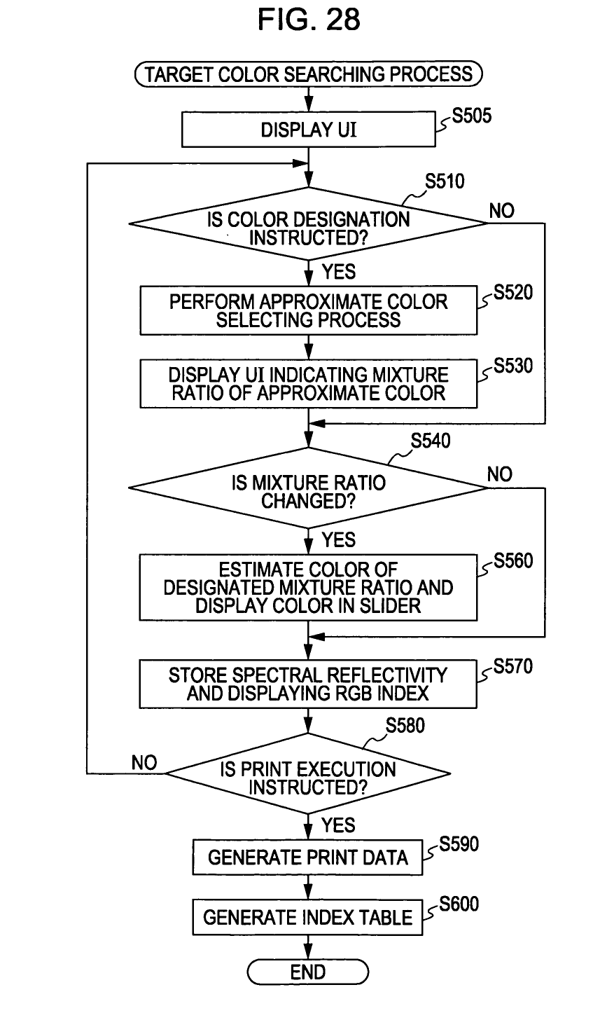

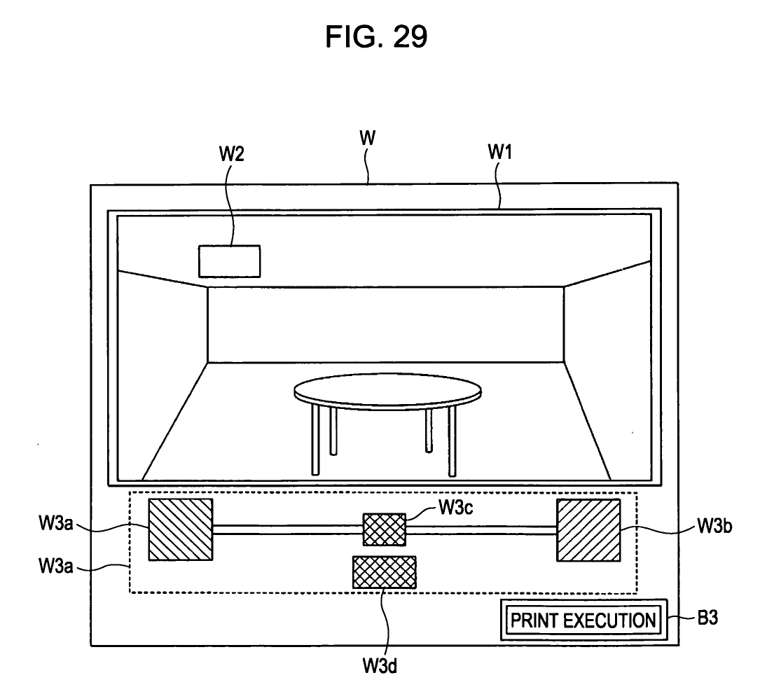

FIG. 28 is a flowchart illustrating a target color searching process performed mainly by the mixed-color print data generating unit P2b. FIG. 29 is a diagram illustrating an example of a user interface (UI) for receiving selection of the index color IC from a user. A UI W shown in the drawing includes an image display frame W1, an index color selection frame W2, a mixed-color ratio designating portion W3. The mixed-color ratio designating portion W3 includes a first approximate color frame W3a, a second approximate color frame W3b, a mixed-color display frame W3c, and an index color display frame W3d. The image display frame W1 is an area where an image is displayed on the basis of the image data designated by a user. The index color selection frame W2 is a selection frame surrounding a part of the image displayed on the image display frame W1. When a predetermined operation is input, a color inside a selection frame is set as the index color IC. The index color set in the index color selection frame W2 is displayed on the index color frame W3c. In addition, when the color of the index color selection frame W2 is not a mono-color, but plural colors, an average color of the color inside the frame is set as the index color IC.

The mixed-color ratio designating portion W3 displays the first approximate color frame W3a and the second approximate color frame W3b displaying a first approximate color and a second approximate color as colors of color materials, which are a mixed-color source for reproducing the index color IC, respectively, so that the approximate color frames are separated from each other. The approximate color frames are connected to each other by a bar. As a slider movable along the bar, the mixed-color display frame W3c is displayed at a location which is based on the mixed-color ratio of the approximate colors. On the mixed-color display frame W3c, a color formed by mixing the approximate colors at the mixed-color ratio corresponding to the location is displayed. On the index color display frame W3d, the index color IC set in the index color selection frame W2 is displayed. The index color display frame W3d and the mixed-color display frame W3c are disposed in a row and configured to search a color close to the target color TC by changing the mixed-color ratio while comparing the mixed-color to the index color IC. This modified example describes the example in which two colors are mixed and the target color is searched. However, three or more colors may be mixed and the target color may be searched. For example, when three colors are mixed, each approximate color as a mixed-color source is displayed at each vertex of a triangle and a mixed-color display frame is displayed inside the triangle. In addition, the mixed-color display frame is configured to be movable inside the triangle. As in the mixed color of four colors in the above-described embodiment, the mixed color according to the location can be calculated and displayed on the mixed-color display frame.

In the above-described embodiment, the target spectral reflectivity Rₜ (λ) is actually measured and the index table corresponding the target spectral reflectivity Rₜ (λ) to the index is created. However, an index table in which plural indexes and plural target spectral reflectivities Rₜ (λ) are registered in advance may be prepared. In this modified example, there is provided an index table in which a correspondence relation between an index given to each pigment made by a pigment maker and target spectral reflectivity Rₜ (λ) formed by measuring the surface applied with each pigment is registered. In the index table, a display RGB is also registered, like the above-described embodiment. When the index table is prepared in advance, a process of selecting a pigment (index) intended to be reproduced in the sample chart SC is performed by the APL P2 in Step S100.

When the process in FIG. 28 starts, the UI W in FIG. 29 is displayed in Step S505. Subsequently, in Step S510, selection of the index color IC is received. More specifically, when a user moves a mouse pointer to the image display frame W1 of the UI and operates clicking, for example, an image selection window or the like for displaying the image display frame W1 to receive the selection of the image data is displayed. When the user selects a file of the image data containing the index color IC on the image selection window, the selected image data is received and an image corresponding to the image data is displayed on the image display frame W1. Next, the index color display frame W2 is displayed inside the image display frame W1. The index color display frame W2 is moved inside the image display frame W1 in accordance with operation of cursor movement keys or movement of a mouse. The user sets the color of the index color display frame W2 to the index color IC by operating the cursor movement keys or the mouse so as to contain a color closest to a user image inside the index color display frame W2 and clicking a selection key or a mouse right button. In addition, when the size of the index color display frame W2 is configured to be changed or a frame displaying an average color of colors of pixels surrounded by the index color display frame W2 is independently provided, it is easier for the user to select the appropriate index color IC. In this way, the index color IC designated by use of the index color display frame W2 is acquired as an RGB value (index color RGB value). When the setting of the index color ends, the condition in Step S510 is satisfied and the process proceeds to Step S520.

In Step S520, a process of selecting an approximate color used to reproduce the index color IC is performed. In this process, a color in a predetermined range with reference to the index color IC is first extracted among colors registered in the index table. That is because there is a possibility of not obtaining the index color when colors considerably distant from the index color IC are mixed. The index table, the displaying RGB value is set, as described above. For example, assuming that the RGB value of the index color is P1=(R0, G0, B0), the RGB value satisfying the following condition is extracted from the index table:

R0−Δr≦R≦R0+Δr,

G0−Δg≦G≦G0+Δg, and

B0−Δb≦B≦B0+Δb.

In this condition expression, Δr, Δg, and Δb are constants determined according to the density of the index in a color space. That is, the constants are determined so that a predetermined number of displaying RGB values are contained in a range defining this condition expression. That is because when the number of contained indexes is too small, there is a possibility that a line connecting arbitrary two colors of the contained indexes is remote from the index color IC.

When the range of the approximate color is designated, the range may be designated so that one of color attributes such as brightness, saturation, and hue is preferred. That is, an operation of designating the color attribute which is most similar to that between the index color prepared by the user and the supposed target color is input by the user. In addition, the range is designated so that an index which is likely not to change the designated attribute is designated as a candidate of the approximate color. For example, when the hue of the index color is similar to the hue of the target color but the brightness or definition deviates, the range is designated by placing strong restraint on the hue.

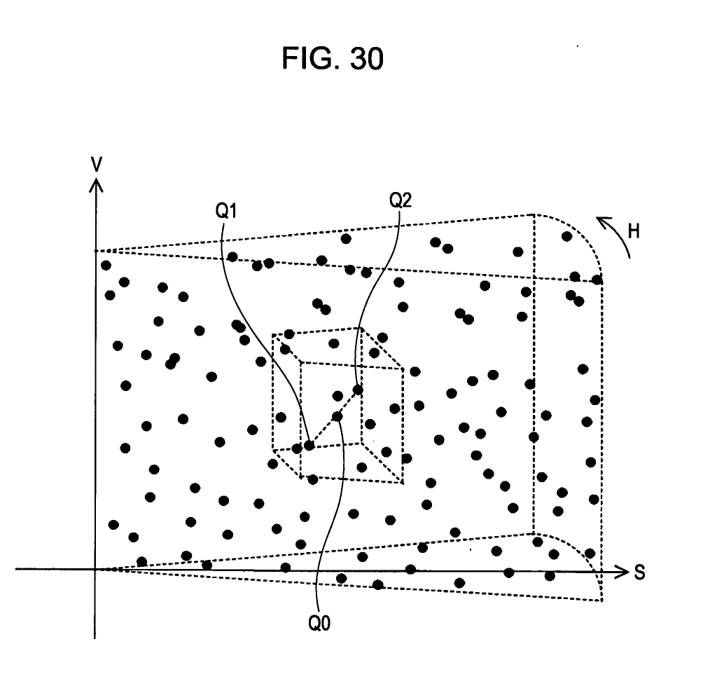

FIG. 30 is an explanatory diagram illustrating a method of designating the range on the basis of a color attribute. In order to designate the range obtained from a distribution of the color sample shown in the drawing, the displaying RGB value of the index and the index color RGB value described above are first converted into an HSV color space (which is a color space in which brightness, saturation, and hue are used as a variable) by a known conversion expression, for example. In the HSV space, a sectional fan-shaped space where a hue angle (H value) of the HSV value (Q0) into which the index color RGB value is converted within ±5° is specified. That is, a space where the hue angle is approximate to the index color is specified. Next, there is specified a circular space where the brightness V and the saturation S of the HSV value (Q0) into which the index color RGB value is converted become the brightness V and the saturation S which are within ±5° in the HSV space. That is, a space where the brightness V and the saturation S are approximate to the index color is specified. The color attribute of the index contained in the range designated in this manner is approximate to the index color.

When the designating of the range is completed, a combination of the approximate colors which are most suitable to reproduce the index color is selected among the extracted RGB values. In the selection, arbitrary two colors (coordinates of each color are X and Y for description) are selected from each extracted color point and a combination in which a Euclidian distance d0 of a segment XY and the index color RGB value A is smallest is selected as a first approximate color AC1 and a second approximate color AC2. In this way, b positioning the index color IC at a location close to the segment between the first approximate color AC1 and the second approximate color AC2, it is possible to select the combination of the approximate colors capable of reproducing the color close to the index color IC.

In the selection, the approximate color RGB value may be selected in consideration of a distance d1 between each point X and the index color RGB color or a distance d2 between each point Y and the index color RGB value as well as the distance d0. That is because reproduction of the index color is sometimes realized better in a mixed color of two colors of which color points are close to each other even when the axes thereof deviate from each other than in a color reproduced by mixing two colors when the points thereof are distant from each other in a color space even in a case where the points are present on the axis connecting the two colors. Specifically, the distance d0 is multiplied by a weight w1 and the distances d1 and d2 are multiplied by a weight w2. When the products are added, an evaluation expression w1Z+w2(d1+d2) is obtained. Then, the combination minimizing this expression is selected as the approximate color RGB value.

In Step S530, the index color IC designated in Step S510 and the approximate colors AC1 and AC2 selected in Step S520 are displayed on the lower portion of the UI shown in FIG. 29. That is, the index color IC is displayed on the index color display frame W3d, the approximate color AC1 is displayed on the first approximate color frame, and the approximate color AC2 is displayed on the second approximate color frame W3b. The result of the mixed color of the approximate colors AC1 and AC2 is displayed on the mixed-color display frame W3c. In addition, as for the mixed color displayed on the slider in an initial state, the result of the mixed color formed by mixing the respective halves of the approximate colors may be displayed, or the mixed color obtained by mixing the approximate colors at a ratio of distances between the index color RGB value and the respective approximate color RGB values may be displayed.

In Step S540, it is determined whether an operation of instructing change of the color mixture ratio is input. When the operation is input, the process proceeds to Step S560. Alternatively, when the operation is not input, the process proceeds to Step S580. On the UI in FIG. 29, the change of the color mixture ratio is performed by moving the slider along the bar. When the bar is closer to the first approximate color, the color mixture ratio of the first approximate color is increased. When the bar is closer to the second approximate color, the color mixture ratio of the second approximate color is increased. For example, when a relation of [a distance between the slider and the first approximate color]:[a distance between the slider and the second approximate color]=a:b is assumed, the color mixture ratio of the first approximate color is b(a+b) and the color mixture ratio of the second approximate color is a/(a+b). Of course, the invention is not limited thereto.

In Step S560, a color having the designated color mixture ratio is displayed on the slider. That is, the spectral reflectivity R′mix (λ) of the mixed color obtained by mixing the first approximate color AC1 and the second approximate color AC2 at the use ratio designated on the slider is estimated. The spectral reflectivity of the mixed color can be calculated by linear combination in which the spectral reflectivity R′mix (λ) of each color sample is weighted in accordance with the use ratio or by the neugebauer model or the like in the spectral printing model described in Section 4. For example, the spectral reflectivity R′mix (λ) of the mixed color formed by mixing spectral reflectivity R1 (λ) of the first approximate color AC1 and spectral reflectivity R2 (λ) of the second approximate color AC2 at a ratio of f1:f2 (where f1+f2=1, 0≦f1≦1, 0≦f2≦1) is calculated by use of an expression of R′mix (λ)=f1×R1 (λ)+f2×R2 (λ).

Likewise, when the mixed color of the first and the second approximate colors is calculated by use of the cell division Yule-Nielsen spectral neugebauer model of the spectral printing model, the first and second approximate colors are used instead of the ink set (CMY, CMYKlclm, or the like) in the spectral printing model in Section 4 and the use ratio designated on the slider is used instead of the ink amount set.

When the calculation of the spectral reflectivity R′mix (λ) is completed in Step S560, the proper index is generated in Step S570 and the index is stored in the RAM 12 in correspondence with the spectral reflectivity data RD. As for the spectral reflectivity data RD, the color value (L*a*b value) in the CIELAB color space upon radiating the D65 light source as the most standard light source is calculated. In addition, the L*a*b value is converted into an RGB value by use of a predetermined RGB profile and the RGB value is stored as the displaying RGB value in the RAM 12 in correspondence with the color measurement data MD. The RGB profile is a profile defining a color-matching relation between the CIELAB color space as an absolute color space and the RGB color space in this embodiment. For example, an ICC profile can be used. Calculation of the displaying RGB value from the spectral reflectivity data RD is performed in the same manner as that of the print data generating process described above. Therefore, the description is omitted.

Subsequently, in Step S580, click of a button W4 for executing the mixed-color printing is detected. When the click is not detected, the process returns to Step S410. Alternatively, the click of the button W4 for executing the mixed-color printing is detected, the PDG P2c generates the print data PD in Step S590. The print data is generated in the same manner as that in the print data generating process described above. When the print data PD is generated, the PDG P2c generates the index table IDB in Step S600. The index table IDB is generated in the same manner as that in the print data generating process described above. When the generation of the index table IDB is completed, the print data PD is output to the PDV P3b through the GDI P1a or the spooler P1b. On the other hand, the index table IDB is directly output to the PDV P3b.

### CROSS-REFERENCE TO RELATED APPLICATIONS

The entire disclosure of Japanese Patent Application No. 2007-339576 filed Dec. 28, 2007, and Japanese Patent Application No. 2008-306766, filed Dec. 1, 2008, are expressly incorporated by reference herein.

What is claimed is:

1. A printing control device which designates a color material amount set, which is a combination of use amounts of color materials of a first color material group, when permitting the printing apparatus to perform printing by attaching the color materials of the first color material group onto a print medium, the printing control device comprising:
a printing control unit which designates the color material amount set corresponding a designated index to the printing apparatus to permit the printing apparatus to perform the printing with reference to a lookup table defining a correspondence relation between the color material amount set and the index,
wherein the lookup table defines a correspondence relation between the color material amount set and the index specifying a mixed color, which is created by use of a second color material group different from the first color material group, the color material amount set being estimated so that spectral reflectivity approximate to spectral reflectivity estimated by a predetermined estimation model on the basis of spectral reflectivity of each of color materials of the second color material group as a mixed-color source and a use ratio of the color materials of the second color material group in the mixed color is reproduced on the print medium.

2. The printing control device according to claim 1, wherein a color material amount set estimating unit estimates the color material amount set by permitting a spectral reflectivity estimating unit to repeatedly change a use ratio of the color materials of the first color material group so that a result estimated by the spectral reflectivity estimating unit on the basis of spectral reflectivity of each of the color materials of the first color material group and the use ratio of the color materials of the first color material group becomes spectral reflectivity approximate to spectral reflectivity of the mixed color.

3. The printing control device according to claim 1, wherein the estimation of the color material amount set is performed on the basis of an evaluation value used to evaluate approximation to the spectral reflectivity of the mixed color, while adding a weight which is different depending on a wavelength.

4. The printing control device according to claim 3, wherein the weight is set on the basis of a spectral sensitivity characteristic of human eyes.

5. The printing control device according to claim 3, wherein the weight is set on the basis of target spectral reflectivity.

6. The printing control device according to claim 3, wherein the weight is set on the basis of a spectral energy distribution of a predetermined light source.

7. A printing system which includes a printing apparatus performing printing by attaching a first color material group onto a print medium and a printing control device designating a color material set, which is a combination of use amounts of color materials of the first color material group, to the printing apparatus to permit the printing on the basis of the color material amount set,
wherein the printing apparatus includes a printing unit which designates the color material amount set corresponding to a designated index to the printing apparatus to permit the printing with reference to a lookup table defining a correspondence relation between the color material amount set and the index,
wherein the lookup table defines a correspondence relation between the color material amount set and the index specifying a mixed color, which is created by use of a second color material group different from the first color material group, the color material amount set being estimated so that spectral reflectivity approximate to spectral reflectivity estimated by a predetermined estimation model on the basis of spectral reflectivity of color materials of the second color material group as a mixed-color source and a use ratio of the color materials of the second color material group in the mixed color is reproduced on the print medium, and
wherein the printing apparatus further includes a printing execution unit which performs the printing on the basis of the color material amount set.

8. A computer readable printing control program which causes a computer to execute a function of permitting a printing apparatus to perform printing on the basis of a color material amount set, which is a combination of use amounts of color materials in a first color material group, when permitting the printing apparatus to perform printing by attaching the color materials of the first color material group to a print medium, the computer readable printing control program causing the computer to execute:
a printing function which designates the color material amount set corresponding a designated index to the printing apparatus to permit the printing apparatus to perform the printing with reference to a lookup table defining a correspondence relation between the color material amount set and the index
wherein the lookup table defines a correspondence relation between the color material amount set and the index specifying a mixed color, which is created by use of a second color material group different from the first color material group, the color material amount set being estimated so that spectral reflectivity approximate to spectral reflectivity estimated by a predetermined estimation model on the basis of spectral reflectivity of color materials of the second color material group as a mixed-color source and a use ratio of the color materials of the second color material group in the mixed color is reproduced on the print medium.
